(19) United States
(12) Patent Application Publication
(10) Pub. No.: US 2026/0017346 A1
(43) Pub. Date: Jan. 15, 2026

(54) GROUND-TRUTH-LESS PERFORMANCE PREDICTION OF GENERATIVE QUESTION-ANSWERING SYSTEMS

(71) Applicant: International Business Machines Corporation, Armonk, NY (US)

(72) Inventors: Ella Rabinovich, Hod Hasharon (IL); Samuel Solomon Ackerman, Haifa (IL); ORNA RAZ, Haifa (IL); Eitan Daniel Farchi, Pardes Hana (IL); Ateret Anaby - Tavor, Givat Ada (IL)

(21) Appl. No.: 18/771,051

(22) Filed: Jul. 12, 2024

(51) Int. Cl. G06F 18/2415; G06N 3/0475

(52) U.S. Cl. CPC G06F 18/2415; G06N 3/0475

(57) ABSTRACT

Systems and techniques that facilitate ground-truth-less performance prediction of generative question-answering systems are provided. In various embodiments, a system can access a large language model (LLM) and a natural language question for which a ground-truth answer is unavailable. In various aspects, the system can generate, via a machine learning classifier that receives as input a set of properties associated with the natural language question, a classification label indicating whether or not the large language model will correctly answer the natural language question. In various instances, the set of properties can include a semantic category of the natural language question, a subject popularity of the natural language question, a semantic consistency exhibited by the LLM in response to repeated executions on the natural language question, or a semantic consistency exhibited by the LLM in response to execution on paraphrases of the natural language question.

### BACKGROUND

The subject disclosure relates to generative question-answering, and more specifically to ground-truth-less performance prediction of generative question-answering systems.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can facilitate ground-truth-less performance prediction of generative question-answering systems are described.

According to one or more embodiments, a system is provided. In various aspects, the system can comprise a processor that can execute computer-executable components stored in a non-transitory computer-readable memory. In various instances, the computer-executable components can comprise an access component that can access a large language model and a natural language question for which a ground-truth answer is unavailable. In various cases, the computer-executable components can comprise a prediction component that can generate, via a machine learning classifier that receives as input a set of properties associated with the natural language question, a classification label indicating whether or not the large language model will correctly answer the natural language question.

In various aspects, the above-described systems can be implemented as computer-implemented methods or as computer program products.

### DESCRIPTION OF THE DRAWINGS

FIG. 1 illustrates a block diagram of an example, non-limiting system that facilitates ground-truth-less performance prediction of generative question-answering systems in accordance with one or more embodiments described herein.

FIG. 2 illustrates a block diagram of an example, non-limiting system including a machine learning classifier, a set of question properties, and a performance classification label that facilitates ground-truth-less performance prediction of generative question-answering systems in accordance with one or more embodiments described herein.

FIG. 3 illustrates an example, non-limiting block diagram of a set of question properties in accordance with one or more embodiments described herein.

FIG. 4 illustrates an example, non-limiting block diagram showing how a semantic category of a natural language question can be determined in accordance with one or more embodiments described herein.

FIG. 5 illustrates an example, non-limiting block diagram showing how a subject popularity of a natural language question can be determined in accordance with one or more embodiments described herein.

FIG. 6 illustrates an example, non-limiting block diagram showing how a same-question semantic consistency of a natural language question can be determined in accordance with one or more embodiments described herein.

FIGS. 7-8 illustrate example, non-limiting block diagrams showing how a paraphrased-question semantic consistency of a natural language question can be determined in accordance with one or more embodiments described herein.

FIG. 9 illustrates an example, non-limiting block diagram showing how a performance classification label can be generated in accordance with one or more embodiments described herein.

FIG. 10 illustrates an example, non-limiting block diagram showing how various artificial intelligence models can be trained in accordance with one or more embodiments described herein.

FIG. 11 illustrates example, non-limiting experimental results in accordance with one or more embodiments described herein.

FIG. 12 illustrates an example, non-limiting table in accordance with one or more embodiments described herein.

FIG. 13 illustrates a flow diagram of an example, non-limiting computer-implemented method that facilitates ground-truth-less performance prediction of generative question-answering systems in accordance with one or more embodiments described herein.

FIG. 14 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A large language model (LLM), such as ChatGPT, can be trained (e.g., via supervised training, unsupervised training, or reinforcement learning) to synthesize textual answers in response to inputted textual questions. When an LLM is executed on a factual or factoid question (e.g., a close-ended question that can be answered by a short, straightforward response that is binarily correct or incorrect, as opposed to an open-ended question that can be answered by long responses that are neither correct nor incorrect), it can be desired to determine whether or not whatever answer is synthesized by the LLM is correct. However, it can sometimes be the case that ground-truth answers to factual or factoid questions are unavailable. Accordingly, when an LLM is executed on a given factual or factoid question that lacks a ground-truth answer, determining whether or not the LLM has generated, or is likely to generate, a correct answer for the given factual or factoid question can be a non-trivial task. Phrased differently, it can be non-trivial to predict generative question-answering performance in the absence of ground-truths.

Unfortunately, there are no existing techniques that facilitate prediction of generative question-answering performance in the absence of ground-truths. Indeed, existing techniques facilitate only query performance prediction, which pertains to search engines rather than LLMs. In particular, query performance prediction involves determining or estimating a search engine's (e.g., Google® search) retrieval quality in response to a query without relying on relevance judgments. Because LLMs are generative machine learning models that bear almost no resemblance whatsoever to search engines, existing techniques for facilitating query performance prediction with respect to search engines cannot easily or readily be applied to LLMs. After all, the factors that query performance prediction takes into consideration (e.g., database schema, size, or organization; database content histograms; choice of join algorithm; choice of index usage strategy) carry no meaning with respect to LLMs (e.g., LLMs do not have a database schema; LLMs do not have database content histograms; LLMs do not choose join algorithms; LLMs do not have index usage strategies).

Accordingly, existing techniques can be considered as suffering from various technical problems.

Various embodiments described herein can ameliorate or address one or more of these technical problems. Various embodiments described herein can include systems, computer-implemented methods, apparatus, or computer program products that can facilitate ground-truth-less performance prediction of generative question-answering systems. In particular, various embodiments described herein can involve training a machine learning classifier to predict whether or not an LLM is likely to generate a correct answer to a given question, where such machine learning classifier can receive as input a set of properties that are associated with the given question. In some cases, the set of properties can include a semantic category to which the given question belongs. In some aspects, the set of properties can include a popularity of a grammatical subject or object of the given question. In some instances, the set of properties can include a semantic consistency exhibited by the LLM in response to repeated execution on the given question. In various cases, the set of properties can include a semantic consistency exhibited by the LLM in response to execution on paraphrases of the given question. In any case, the set of properties can be considered as being indicative or correlative of the ability of the LLM to correctly respond to the given question (e.g., the LLM can be more likely to correctly synthesize responses to certain categories of questions than to other categories of questions; the LLM can be more likely to correctly synthesize responses to questions that pertain to more popular subject matter than to questions that pertain to less popular subject matter; if the LLM exhibits low variability in the answers that it synthesizes for a certain question, those answers can be more likely to be correct; if the LLM exhibits low variability in the answers that it synthesizes for paraphrases of a certain question, those answers can be more likely to be correct). Accordingly, the set of properties can be fed as input to the machine learning classifier, and the machine learning classifier can produce as output a classification label that indicates whether or not the LLM will correctly answer the given question. In this way, the question-answering performance of the LLM with respect to the given question can be predicted, even though a ground-truth answer to the given question might be unavailable.

Various embodiments described herein can be considered as a computerized tool (e.g., any suitable combination of computer-executable hardware or computer-executable software) that can facilitate ground-truth-less performance prediction of generative question-answering systems. In various aspects, such a computerized tool can comprise an access component, a prediction component, or an action component.

In various embodiments, there can be a plain text question. In various aspects, the plain text question can be one or more unstructured or natural language sentences or sentence fragments that semantically request the identification of any suitable factual or factoid information pertaining to any suitable substantive topic (e.g., “What is Person A's occupation?”; “Who is hosting Event B?”; “When was Book C written?”; “What is the address of Building D?”). In various instances, the plain text question can be provided by any suitable user via any suitable human-computer interface device (e.g., keyboard, keypad, touchscreen, voice transcription system).

In various embodiments, there can be an LLM. In various aspects, the LLM can exhibit any suitable deep learning internal architecture. For example, the LLM can include any suitable numbers of any suitable types of layers (e.g., input layer, one or more hidden layers, output layer, any of which can be convolutional layers, dense layers, long short-term memory (LSTM) layers, transformer layers, non-linearity layers, pooling layers, batch normalization layers, or padding layers). As another example, the LLM can include any suitable numbers of neurons in various layers (e.g., different layers can have the same or different numbers of neurons as each other). As yet another example, the LLM can include any suitable activation functions (e.g., softmax, sigmoid, hyperbolic tangent, rectified linear unit) in various neurons (e.g., different neurons can have the same or different activation functions as each other). As still another example, the LLM can include any suitable interneuron connections or interlayer connections (e.g., forward connections, skip connections, recurrent connections).

Regardless of its specific internal architecture, the LLM can be configured as a generative text-to-text model. That is, the LLM can be configured to receive as input any suitable textual data (which, in various cases, may or may not be accompanied by any suitable numerical data or any suitable graphical data), and the LLM can be configured to produce as output synthesized textual content (e.g., one or more synthesized sentences or sentence fragments) that is semantically or substantively based on such inputted textual data (and based on accompanying numerical or graphical data, as appropriate).

In order to accomplish this, the LLM can be considered as comprising an encoder portion and a synthesizer portion. In various aspects, the encoder portion can be any suitable upstream layers of the LLM that are configured to receive the inputted textual data (and any accompanying numerical or graphical data, as appropriate) and to produce embeddings based on that inputted textual data. In various instances, the synthesizer portion can be any suitable downstream layers of the LLM that are configured to receive those embeddings and to produce the synthesized textual content based on those embeddings.

In various aspects, an embedding produced by the encoder portion of the LLM in response to a piece of inputted textual, numerical, or graphical data can be considered as any suitable mathematical quantity (e.g., scalar, vector, matrix, tensor, tokenization, or any suitable combination thereof) that numerically represents at least some substantive or semantic aspect of that inputted textual, numerical, or graphical data in a low-dimensional fashion. In other words, the embedding can be smaller in terms of size or dimensionality (e.g., in some cases, one or more orders of magnitude smaller) than such inputted textual, numerical, or graphical data; but despite such smaller size, the embedding can nevertheless be considered as substantively or semantically representing such inputted textual, numerical, or graphical data. In still other words, the embedding can be considered as a latent vector representation of such inputted textual, numerical, or graphical data.

In any case, it can be desired to leverage the LLM so as to automatically answer the plain text question. However, a ground-truth response to the plain text question can be unavailable. Despite such ground-truth unavailability, it can be desired to determine or predict whether or not the LLM will or is likely to correctly answer the plain text question. In various instances, the computerized tool described herein can accomplish such determination or prediction.

In various embodiments, the access component of the computerized tool can electronically access the plain text question or the LLM. For instance, the access component can receive, retrieve, or otherwise obtain the plain text question or the LLM from any suitable centralized or decentralized data structures (e.g., graph data structures, relational data structures, hybrid data structures). In any case, the access component can be considered as a conduit through which other components of the computerized tool can electronically interact with (e.g., read, write, edit, copy, manipulate, execute) the plain text question or the LLM.

In various embodiments, the prediction component of the computerized tool can electronically store, maintain, control, or otherwise access a machine learning classifier. In various aspects, the machine learning classifier can exhibit any suitable internal architecture. As a non-limiting example, the machine learning classifier can exhibit any suitable deep learning internal architecture. In such case, the machine learning classifier can: include any suitable numbers of any suitable types of layers; include any suitable numbers of neurons in various layers; include any suitable activation functions in various neurons; or include any suitable interneuron connections or interlayer connections. As another non-limiting example, the machine learning classifier can exhibit any suitable logistic regression internal architecture. In such case, the machine learning classifier can include any suitable learned coefficients respectively corresponding to regressors or to interactions between respective pairs of regressors. As even other non-limiting examples, the machine learning classifier can exhibit any suitable support vector machine internal architecture, any suitable decision tree internal architecture, or any suitable naïve Bayes internal architecture.

Regardless of its specific internal architecture, the machine learning classifier can be configured to classify the plain text question as either being correctly answerable or incorrectly answerable by the LLM. In particular, the prediction component can execute the machine learning classifier on a set of properties associated with the plain text question, and such execution can cause the machine learning classifier to produce as output a performance classification label. As a non-limiting example, suppose that the machine learning classifier exhibits a deep learning internal architecture. In such case, the prediction component can feed the set of properties to an input layer of the machine learning classifier, the set of properties can complete a forward pass through one or more hidden layers of the machine learning classifier, and an output layer of the machine learning classifier can calculate the performance classification label based on activations provided by the one or more hidden layers of the machine learning classifier. As another non-limiting example, suppose that the machine learning classifier instead exhibits a logistic regression internal architecture. In such case, the prediction component can multiply the set of properties (or any suitable functions thereof) by respective learned coefficients of the machine learning classifier, thereby yielding the performance classification label.

In any case, the performance classification label can binarily or dichotomously indicate either that: the LLM will or is likely (in the opinion of the machine learning classifier) to correctly answer the plain text question; or the LLM will or is likely (in the opinion of the machine learning classifier) to instead incorrectly answer the plain text question. In other words, the set of properties can be considered as containing or conveying information regarding the plain text question that is indicative of, suggestive of, dispositive of, or otherwise somehow related to the LLM's ability to correctly generate or synthesize an answer to the plain text question, and the machine learning classifier can be considered as recognizing or detecting such information.

In various embodiments, the set of properties can comprise any suitable electronic data that pertains in any suitable way to, or that is otherwise derived in any suitable way from, the plain text question. In other words, the set of properties can be or include any suitable metadata, attributes, or characteristics of the plain text question.

As a non-limiting example, the set of properties can include a semantic category of the plain text question. In particular, there can be a plurality of defined semantic categories to which the plain text question could possibly belong. In various cases, each of the plurality of defined semantic categories can be a distinct class of substantive topic about which the plain text question might be asking (e.g., a games category or class, to which belong questions that ask about identified gaming events; a place-of-birth category or class, to which belong questions that ask where identified people were born; an author category or class, to which belong questions that ask who wrote identified literary works). In some instances, the semantic category of the plain text question can be manually indicated or flagged by a user or operator (e.g., by whatever user provided the plain text question). In other instances, however, the semantic category of the plain text question can be automatically generated via a semantic category classifier (e.g., via a neural network that is trained or configured to receive as input the plain text question and to determine as output to which one of the plurality of defined semantic categories the plain text question belongs). In any case, it can be possible that the LLM is more consistently able to correctly answer questions that belong to certain semantic categories than to other semantic categories (e.g., the LLM might be more likely to correctly answer games-related questions than author-related questions). Accordingly, by including the semantic category of the plain text question, the set of properties can be considered as providing to the machine learning classifier valuable metadata that is indicative of the LLM's ability to correctly answer the plain text question.

As another non-limiting example, the set of properties can include a popularity level of a grammatical subject or object of the plain text question. Indeed, the plain text question can be made up of any suitable number of words, and one or more of those words can be considered as being a grammatical subject (e.g., a noun or noun phrase that performs an action or verb of the plain text question) or a grammatical object (e.g., a noun or noun phrase to or on whom or which the action or verb of the plain text question is performed). For example, if the plain text question is “Who wrote Book C?”, Book C can be considered as a grammatical object of the plain text question (e.g., object of the verb “wrote”). As another example, if the plain text question is “What does Person A do for a living?”, Person A can be considered as a grammatical subject of the plain text question (e.g., subject of the verb “do”). In various aspects, the grammatical subject or object of the plain text question can be automatically identified via named entity recognition (e.g., via a neural network that is trained or configured to receive as input the plain text question and to identify as output a subject or object of the plain text question). In some cases, the grammatical subject or object can be associated with a website (e.g., a Wikipedia® page dedicated to the grammatical subject or object). In some instances, the website can be manually indicated or flagged by a user or operator (e.g., by whatever user provided the plain text question). In other instances, however, the website of the plain text question can be automatically identified, via any suitable web crawler or web browser given the grammatical subject or object. In various aspects, the popularity level of the grammatical subject or object can be equal to or otherwise based on an average monthly view rate or visit rate of the website (e.g., a website that receives more views or visits can be considered as more popular or more well-known; whereas a website that receives fewer views or visits and can be considered as less popular or less well-known). In any case, it can be possible that the LLM is more consistently able to correctly answer questions whose subjects or objects are popular or well-known, than questions whose subjects or objects are unpopular or not well-known. Accordingly, by including the popularity level of the grammatical subject or object of the plain text question, the set of properties can be considered as providing to the machine learning classifier valuable metadata that is indicative of the LLM's ability to correctly answer the plain text question.

As yet another non-limiting example, the set of properties can include a same-question semantic consistency that the LLM exhibits with respect to the plain text question. More specifically, the LLM can, in some aspects, operate in a greedy decoding mode or instead in a non-greedy decoding mode. While in the greedy decoding mode, the LLM can sequentially generate answers to inputted questions in a deterministic fashion. In contrast, while in the non-greedy decoding mode, the LLM can sequentially generate answers to inputted questions in a stochastic or probabilistic fashion. In various aspects, the prediction component can execute the LLM on the plain text question multiple times in the non-greedy decoding mode, and such executions can cause the LLM to generate multiple synthesized answers in response to the plain text question. Because the LLM can be operated in the non-greedy decoding mode, the LLM can generate the multiple synthesized answers stochastically, such that it is possible for the multiple synthesized answers to not be identical with each other. In various instances, those multiple synthesized answers can be converted into embeddings via any suitable encoding technique (e.g., via the encoder portion of the LLM), and the prediction component can compute the same-question semantic consistency based on those multiple embeddings. In particular, the same-question semantic consistency can be equal to or otherwise based on a mean pairwise cosine similarity of those multiple embeddings. Thus, the same-question semantic consistency can be a scalar indicating how similar or dissimilar the multiple embeddings, and thus the multiple synthesized answers, are to each other. In any case, the more similarity (e.g., the less variability or diversity) that is exhibited by those multiple synthesized answers, the more confidence there can be that the LLM is likely to correctly answer the plain text question. Accordingly, by including the same-question semantic consistency, the set of properties can be considered as providing to the machine learning classifier valuable metadata that is indicative of the LLM's ability to correctly answer the plain text question.

As even another non-limiting example, the set of properties can include a paraphrased-question semantic consistency that the LLM exhibits with respect to the plain text question. In particular, there can be a set of paraphrases of the plain text question, where a paraphrase can be one or more unstructured or natural language sentences that are non-identical to the plain text question but that nevertheless are semantically or substantively equivalent to the plain text question (e.g., “What is Person A's occupation?” can be paraphrased as “What does Person A do for a living?”). In some instances, the set of paraphrases of the plain text question can be manually crafted by a user or operator (e.g., by whatever user provided the plain text question). In other instances, however, the set of paraphrases of the plain text question can be automatically generated via templating (e.g., subjects, objects, or verbs of the plain text question can be identified via named entity recognition and can be inserted into respective text fields of pre-made paraphrase templates) or via artificial intelligence paraphrasing (e.g., via a neural network that is trained or configured to receive as input the plain text question and to produce as output a paraphrase of the plain text question). In various aspects, the prediction component can execute the LLM on the plain text question and on the set of paraphrases (e.g., in either the non-greedy decoding mode or the greedy decoding mode), and such executions can cause the LLM to generate a set of synthesized answers. In various instances, that set of synthesized answers can be converted into a set of embeddings via any suitable encoding technique, and the prediction component can compute the paraphrased-question semantic consistency based on that set of embeddings. Specifically, the paraphrased-question semantic consistency can be equal to or otherwise based on a mean pairwise cosine similarity of that set of embeddings. So, the paraphrased-question semantic consistency can be a scalar indicating how similar or dissimilar that set of embeddings, and thus the set of synthesized answers, are to each other. In any case, the more similarity (e.g., the less variability or diversity) that is exhibited by that set of synthesized answers, the more consistently the LLM can be considered as treating paraphrases of the plain text question, and thus the more confidence there can be that the LLM is likely to correctly answer the plain text question. Accordingly, by including the paraphrased-question semantic consistency, the set of properties can be considered as providing to the machine learning classifier valuable metadata that is indicative of the LLM's ability to correctly answer the plain text question.

In any case, the prediction component can execute the machine learning classifier on the set of properties of the plain text question, and such execution can yield the performance classification label, which can indicate whether or not the LLM is likely to correctly answer the plain text question. In this way, the machine learning classifier can be considered as predicting the question-answering performance of the LLM with respect to the plain text question, notwithstanding that a ground-truth answer to the plain text question might not be available.

In various embodiments, the action component of the computerized tool can electronically perform or initiate any suitable electronic actions based on the performance classification label. As a non-limiting example, the action component can electronically render the performance classification label on any suitable electronic display (e.g., a computer screen that is viewable by the user that provided the plain text question). As another non-limiting example, the action component can electronically transmit the performance classification label to any suitable computing device (e.g., to a computing device of the user that provided the plain text question). Accordingly, the action component can be considered as notifying whichever user provided the plain text question of whether or not the LLM can confidently generate a correct answer for the plain text question. In other words, the action component can be considered as alerting the user to whether or not the LLM can be trusted to accurately answer the plain text question, even though a ground-truth answer to the plain text question might be unavailable. Thus, the user can know whether or not to disregard answers synthesized by the LLM in response to the plain text question. In some cases, the component can automatically delete answers generated by the LLM, in response to the performance classification label indicating that the LLM is not likely to correctly answer the plain text question.

Note that, in order for the performance classification label to be reliable, the machine learning classifier can first undergo training. In various cases, the computerized tool can train the machine learning classifier using any suitable training paradigm (e.g., via supervised training, unsupervised training, or reinforcement learning).

Various embodiments described herein can be employed to use hardware or software to solve problems that are highly technical in nature (e.g., to facilitate ground-truth-less performance prediction of generative question-answering systems), that are not abstract and that cannot be performed as a set of mental acts by a human. Further, some of the processes performed can be performed by a specialized computer (e.g., LLM, classifiers, named entity recognizers, paraphrasers) for carrying out defined acts related to generative question-answering.

For example, such defined acts can include: accessing, by a device operatively coupled to a processor, a large language model and a natural language question for which a ground-truth answer is unavailable; and generating, by the device and via a machine learning classifier that can receive as input a set of properties associated with the natural language question, a classification label indicating whether or not the large language model will correctly answer the natural language question. In some cases, the set of properties can comprise a categorical variable indicating a semantic category to which the natural language question belongs. In some aspects, the set of properties can comprise a continuous variable indicating an amount of popularity of a grammatical subject or grammatical object of the natural language question, wherein the grammatical subject or the grammatical object can be identified via named entity recognition. In particular, the grammatical subject or the grammatical object of the natural language question can correspond to a website, and the continuous variable can be based on a number of monthly views of the website. In some instances, the device can execute the large language model on the natural language question a plurality of times using a non-greedy decoding mode of the large language model, thereby yielding a plurality of first synthesized answers, and the set of properties can comprise a continuous variable indicating a semantic consistency of the plurality of first synthesized answers. In some cases, the device can execute the large language model on the natural language question and on a plurality of paraphrases of the natural language question, thereby yielding a plurality of second synthesized answers, and the set of properties can comprise a continuous variable indicating a semantic consistency of the plurality of second synthesized answers. In various aspects, such semantic consistencies can be computed via mean pairwise cosine similarity calculations.

Such defined acts are inherently computerized. Indeed, artificial intelligence models (e.g., LLMs, machine learning classifiers, named entity recognizers, sentence paraphrasers) are inherently computerized constructs comprising specific software-oriented architectures (e.g., input layers, hidden layers, or output layers, any of which can be made up of trainable or non-trainable internal parameters such as convolutional layers or LSTM layers). Artificial intelligence models cannot be trained or executed by the human mind, or by humans with mere pen and paper, in any reasonable or practicable way without computers. In fact, the technical field of generative question-answering is directed toward enabling computers to synthesize grammatically coherent textual responses to inputted textual questions. It would make no sense whatsoever to discuss any aspect of the field of generative question-answering outside of a computing context or otherwise without reference to computing devices.

Moreover, various embodiments described herein can integrate into a practical application various teachings relating to generative question-answering. As described above, an LLM can be trained or configured to generate textual responses to textual questions. For textual questions that inquire about factual information, it can be desired to determine whether or not the LLM is likely to answer, or has answered, such textual questions correctly. However, ground-truth answers are not always available to facilitate determination of such answer correctness. Existing techniques only determine correctness of retrieval-based search engines. Because LLMs are generative models that bear almost no technical resemblance to retrieval-based search engines, such existing techniques are inapplicable to LLMs. Various embodiments described herein can ameliorate such technical problems by leveraging artificial intelligence classification conditioned on question properties. In particular, when given an LLM and a question, various embodiments described herein can involve computing or extracting a set of properties associated with the question, and executing a trained machine learning classifier (e.g., a neural network, a logistic regressor) on the set of properties. Such execution can yield a performance classification label, that indicates cither: that the LLM will or is likely to correctly answer the given question; or that the LLM will or is likely to incorrectly answer the given question. As described herein, the set of properties can contain any suitable metadata of the given question, such as: a semantic category of the given question; a subject popularity of the given question; a semantic consistency exhibited by the LLM in response to repeated execution on the given question; or a semantic consistency exhibited by the LLM in response to execution on paraphrases of the given question. In any case, the set of properties can be considered as containing or encompassing answer-dispositive or answer-pertinent information regarding the given question, and the machine learning classifier can leverage such information to predict or determine whether or not the LLM is likely to correctly answer the given question. Indeed, the inventors of various embodiments described herein experimentally verified such performance prediction or determination. In this way, various embodiments described herein can be considered as a holistic computational framework for facilitating ground-truth-less performance prediction of generative question-answering. Contrast this with existing techniques, which are limited only to retrieval-based search engines. Thus, various embodiments described herein certainly constitute a tangible and concrete technical improvement, technical effect, or technical advantage in the field of generative question-answering. Accordingly, such embodiments clearly qualify as useful and practical applications of computers.

Furthermore, various embodiments described herein can control real-world tangible devices based on the disclosed teachings. For example, various embodiments described herein can execute real-world artificial intelligence models (e.g., LLM, classifier) on real-world natural language questions, thereby yielding real-world synthesized responses which can be rendered on real-world computer screens or monitors.

It should be appreciated that the herein figures and description provide non-limiting examples of various embodiments and are not necessarily drawn to scale.

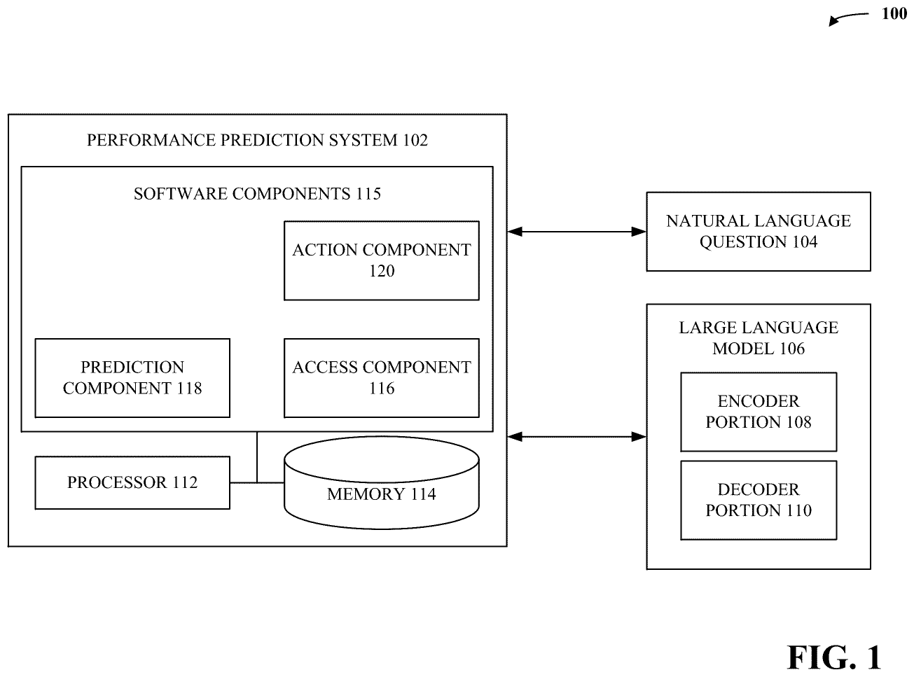

FIG. 1 illustrates a block diagram of an example, non-limiting system 100 that can facilitate ground-truth-less performance prediction of generative question-answering systems in accordance with one or more embodiments described herein. As shown, a performance prediction system 102 can be electronically integrated, via any suitable wired or wireless electronic connections, with a natural language question 104 or with a large language model 106 (hereafter “LLM 106”).

In various embodiments, the natural language question 104 can be any suitable number of plain text or unstructured sentences or sentence fragments that request or command the identification of any suitable factual information or factoid pertaining to any suitable topic. In some aspects, the natural language question can be in an interrogative format, hence the term “question”. As some non-limiting examples, for any suitable Person A, the natural language question 104 can be any of the following: “What is Person A's occupation?”; “How old is Person A?”; or “Who is Person A's parent?”. As more non-limiting examples, for any suitable Event B, the natural language question 104 can be any of the following: “Where did Event B occur?”; “When did Event B occur?”; or “How long did Event B last?”. As even more non-limiting examples, for any suitable Book C, the natural language question 104 can be any of the following: “Who wrote Book C?”; “Who published Book C?”; “When was Book C written?’; or “Who is the protagonist of Book C?”. Note that, despite the term “question,” the natural language question 104 need not be in an interrogative format. Indeed, in various aspects, the natural language question 104 can instead be in an imperative format. For instance, the natural language question 104 can be any of the following: “Identify Person A's occupation.”; “Tell me Person A's age.”; “Determine Person A's parent.”; “Identify where Event B occurred.”; “Tell me when Event B occurred.”; “Determine how long Event B lasted.”; “Identify the author of Book C.”; “Tell me the publisher of Book C.”; or “Determine the protagonist of Book C.” In various cases, a ground-truth answer to the natural language question 104 can be unknown or unavailable.

In various instances, the natural language question 104 can be provided by any suitable user of any suitable computing device (not shown), such as a laptop computer, a desktop computer, a smart phone, a tablet computer, a wearable computer, or a vehicle-integrated computer. As a non-limiting example, the user can type (e.g., via a keyboard, keypad, or touchscreen) the natural language question 104 into any suitable graphical user interface text field of the computing device. As another non-limiting example, the user can verbally speak into any suitable microphone of the computing device, and any suitable speech-to-text transcription system, service, or technique can convert the spoken words of the user into the natural language question 104.

In various embodiments, the LLM 106 can comprise an encoder portion 108 and a decoder portion 110. In various cases, the encoder portion 108 can be considered as being upstream from the decoder portion 110. Equivalently, the decoder portion 110 can be considered as being downstream of the encoder portion 108.

In various aspects, the encoder portion 108 can exhibit any suitable deep learning internal architecture. Indeed, in various cases, the encoder portion 108 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

Likewise, in various instances, the decoder portion 110 can exhibit any suitable deep learning internal architecture. Indeed, in various cases, the decoder portion 110 can have an input layer, one or more hidden layers, and an output layer. In various instances, any of such layers can be coupled together by any suitable interneuron connections or interlayer connections (e.g., forward connections, skip connections, recurrent connections). Furthermore, in various cases, any of such layers can be any suitable types of neural network layers having any suitable learnable or trainable internal parameters (e.g., any of such input layer, one or more hidden layers, or output layer can be convolutional layers, dense layers, batch normalization layers, LSTM layers, or transformer layers). Further still, in various cases, any of such layers can be any suitable types of neural network layers having any suitable fixed or non-trainable internal parameters (e.g., any of such input layer, one or more hidden layers, or output layer can be non-linearity layers, padding layers, pooling layers, or concatenation layers).

Regardless of the specific internal architecture (e.g., the specific numbers, types, or organizations of layers) that is implemented within the encoder portion 108, the encoder portion 108 can be configured to receive textual data (which can be accompanied by any suitable numerical or graphical data) and to produce embeddings based on such inputted textual data. In contrast, regardless of the specific internal architecture that is implemented within the decoder portion 110, the decoder portion 110 can be configured to receive embeddings produced by the encoder portion 108 and to produce synthesized textual content based on such embeddings. As some non-limiting examples, the LLM 106 can be any of the following: ChatGPT; Genc.AI®; Ollama®; Bard®; Claude®; Scamless®; GitHub CoPilot®; Amazon CodeWhisperer®; Titan®; VIT®; YOLOv8 R; MobileNetV2®; EfficientNet-B5®; OWL-VIT®; BLIP-2®; Amazon Rckognition®; PaLM 2®; BLOOM®; T-5®; or Cohere Command®.

It should be appreciated and understood that FIG. 1 depicts a mere non-limiting example of the LLM 106. In some embodiments, the LLM 106 can exhibit any other suitable construction or architecture. As a non-limiting example, the LLM 106 can omit the encoder portion 108.

In any case, it can be desired to predict or determine whether or not the LLM 106 can, will, or is likely to accurately answer the natural language question 104. As described herein, the performance prediction system 102 can facilitate such prediction or determination, notwithstanding a ground-truth answer to the natural language question 104 being unavailable.

In various embodiments, the performance prediction system 102 can comprise a processor 112 (e.g., computer processing unit, microprocessor) and a non-transitory computer-readable memory 114 that is operably or operatively or communicatively connected or coupled to the processor 112. The non-transitory computer-readable memory 114 can store computer-executable instructions which, upon execution by the processor 112, can cause the processor 112 or other components of the performance prediction system 102 (e.g., access component 116, prediction component 118, action component 120) to perform one or more acts. In various embodiments, the non-transitory computer-readable memory 114 can store computer-executable components (e.g., access component 116, prediction component 118, action component 120), and the processor 112 can execute the computer-executable components.

In various embodiments, the performance prediction system 102 can comprise an access component 116. In various aspects, the access component 116 can electronically access or otherwise electronically communicate in any suitable fashion with the LLM 106 or with the natural language question 104. For instance, the access component 116 can electronically transmit any suitable electronic data to, or receive any suitable electronic data from, the LLM 106. As another instance, the access component 116 can electronically receive or electronically retrieve the natural language question 104 from any suitable electronic source (e.g., from the computing device of whatever user provided the natural language question 104). Accordingly, the access component 116 can be considered as a proxy or conduit by which other components of the performance prediction system 102 can electronically interact with the LLM 106 or with the natural language question 104.

In various embodiments, the performance prediction system 102 can comprise a prediction component 118. In various aspects, the prediction component 118 can, as described herein, electronically execute a machine learning classifier on a set of properties associated with the natural language question 104, thereby yielding a classification label indicating whether or not the LLM 106 can or is likely to correctly answer the natural language question 104.

In various embodiments, the performance prediction system 102 can comprise an action component 120. In various instances, the action component 120 can, as described herein, electronically initiate any suitable actions based on the classification label, such as rendering, transmitting, or otherwise sharing the classification label.

Note that, in various instances, the access component 116, the prediction component 118, and the action component 120 can collectively be considered as being one or more software components 115 of the performance prediction system 102. In various aspects, it should be appreciated that the one or more software components 115 are described primarily herein as comprising three components (e.g., the access component 116, the prediction component 118, and the action component 120) for case of explanation and illustration. However, the one or more software components 115 are not limited to being implemented as exactly such three components in every embodiment. Indeed, in some embodiments, the functionalities described herein of such three components can be combined in any suitable fashions, so as to be implemented in or by fewer than three components (e.g., in some cases, a single component can perform all of the functionalities that are described herein with respect to the access component 116, the prediction component 118, and the action component 120). In other embodiments, the functionalities described herein of such three components can instead be distributed, separated, split, or fragmented in any suitable fashions, so as to be implemented in or by more than three components (e.g., two or more components can facilitate the functionalities that are performable by the access component 116; two or more components can facilitate the functionalities that are performable by the prediction component 118; two or more components can facilitate the functionalities that are performable by the action component 120).

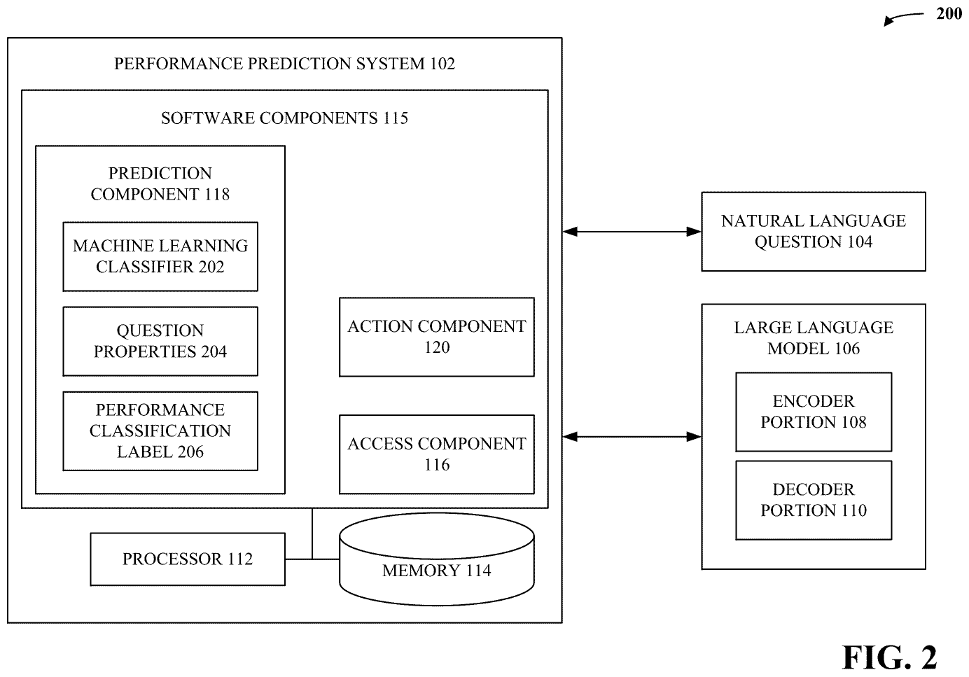

FIG. 2 illustrates a block diagram of an example, non-limiting system 200 including a machine learning classifier, a set of question properties, and a performance classification label that can facilitate ground-truth-less performance prediction of generative question-answering systems in accordance with one or more embodiments described herein. As shown, the system 200 can, in some cases, comprise the same components as the system 100, and can further comprise a machine learning classifier 202, a set of question properties 204, and a performance classification label 206.

In various embodiments, the prediction component 118 can electronically store, electronically maintain, electronically control, or otherwise electronically access the machine learning classifier 202. In various aspects, the machine learning classifier 202 can exhibit any suitable artificial intelligence internal architecture.

For instance, in some cases, the machine learning classifier 202 can exhibit any suitable deep learning internal architecture. Indeed, in various cases, the machine learning classifier 202 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

However, in other cases, the machine learning classifier 202 can instead exhibit any suitable logistic regression internal architecture. In such case, the machine learning classifier 202 can be configured to operate on any suitable number of regressors, and the machine learning classifier 202 can comprise a respective learnable or trainable coefficient for: each unique regressor (e.g., these can be considered as first-order coefficients); or each unique interaction between two or more regressors (e.g., these can be considered as second-order, third-order, or other higher-order coefficients).

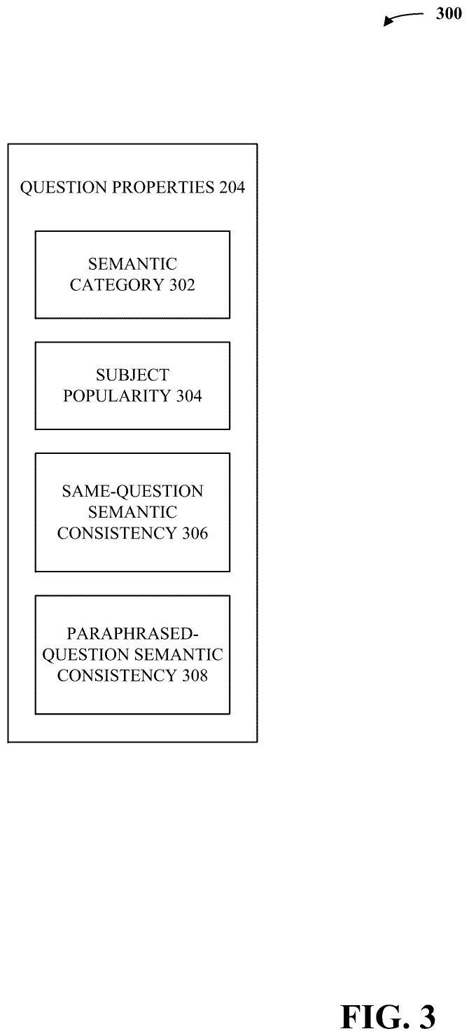

Regardless of its specific internal architecture, the machine learning classifier 202 can be configured to receive as input the set of question properties 204 and to produce as output the performance classification label 206. Non-limiting aspects are described with respect to FIGS. 3-9.

FIG. 3 illustrates an example, non-limiting block diagram 300 of the set of question properties 204 in accordance with one or more embodiments described herein.

In various embodiments, the set of question properties 204 can be any suitable electronic data having any suitable format, size, or dimensionality (e.g., can be one or more scalars, one or more vectors, one or more matrices, one or more tensors, one or more character strings, or any suitable combination thereof) that can convey, indicate, or otherwise represent any suitable metadata, characteristics, or attributes of the natural language question 104. In various aspects, the set of question properties 204 can comprise a semantic category 302 to which the natural language question 104 belongs. In various instances, the set of question properties 204 can comprise a subject popularity 304 associated with the natural language question 104. In various cases, the set of question properties 204 can comprise a same-question semantic consistency 306 which can be exhibited by the LLM 106 in response to repeated execution on the natural language question 104. In various aspects, the set of question properties 204 can comprise a paraphrased-question semantic consistency 308 which can be exhibited by the LLM 106 in response to execution on paraphrases of the natural language question 104. It should be understood and appreciated that the set of question properties 204 can, in various cases, comprise any suitable combination of the semantic category 302, the subject popularity 304, the same-question semantic consistency 306, or the paraphrased-question semantic consistency 308.

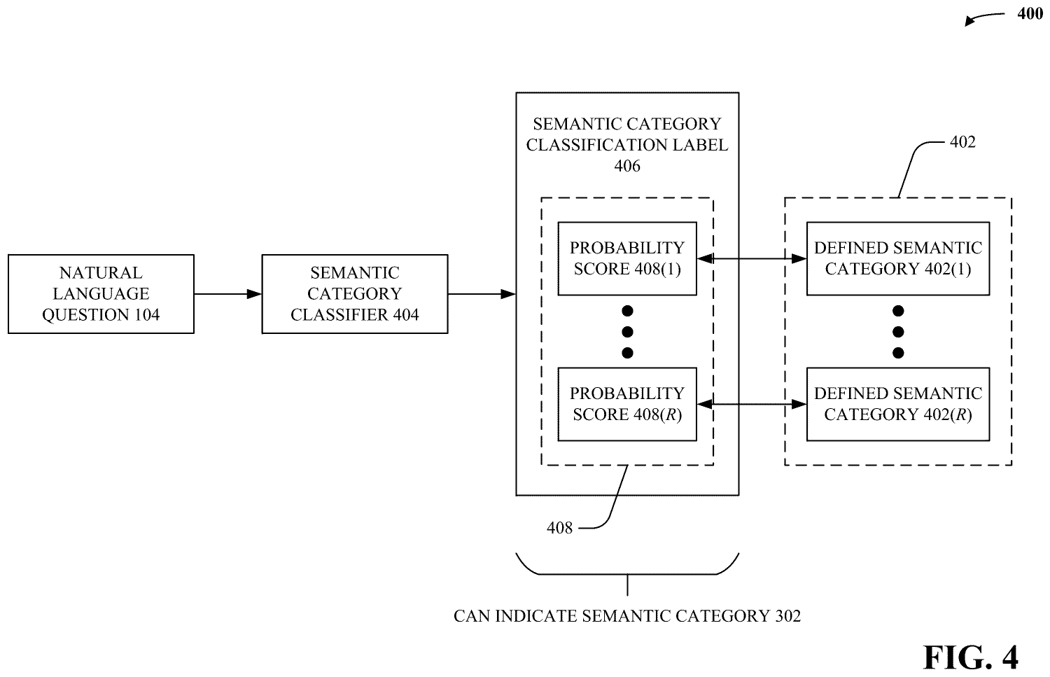

In various aspects, the prediction component 118 can electronically identify the semantic category 302, as described with respect to FIG. 4.

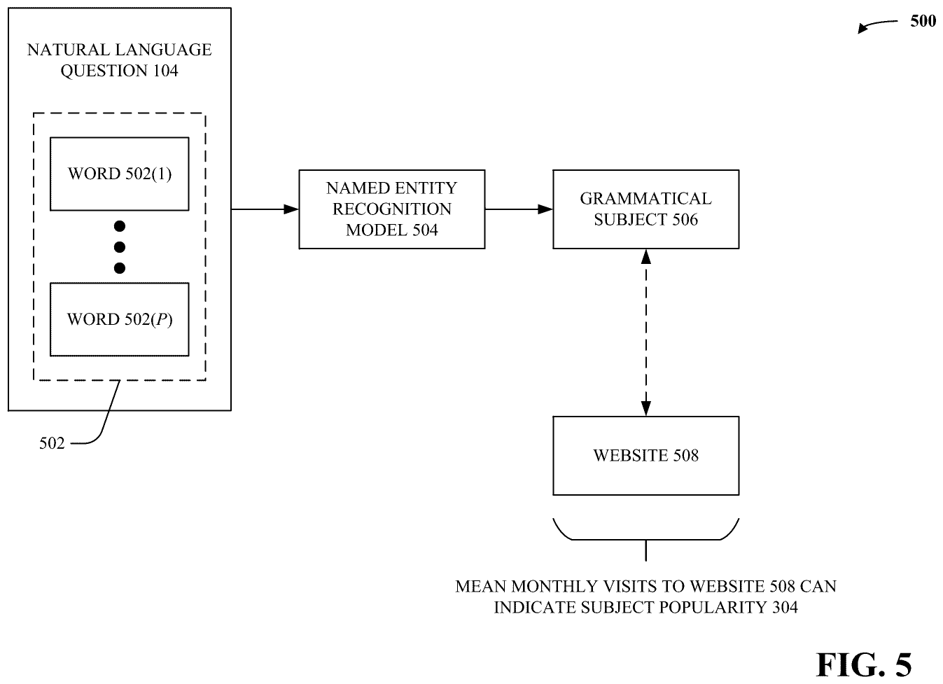

In various instances, the prediction component 118 can electronically identify the subject popularity 304, as described with respect to FIG. 5.

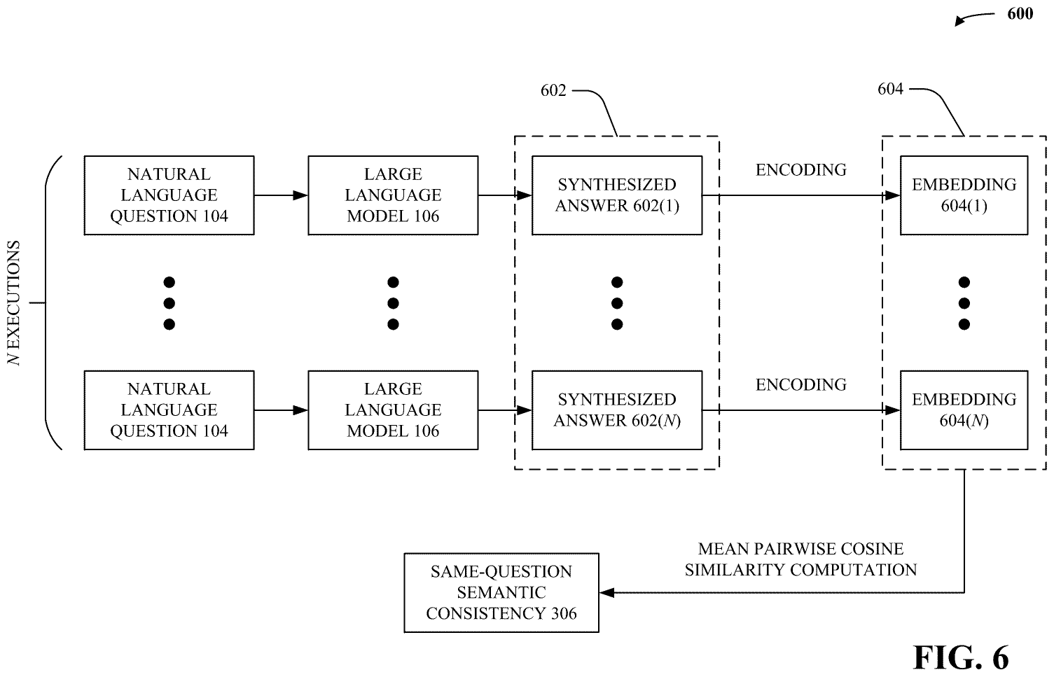

In various cases, the prediction component 118 can electronically identify the same-question semantic consistency 306, as described with respect to FIG. 6.

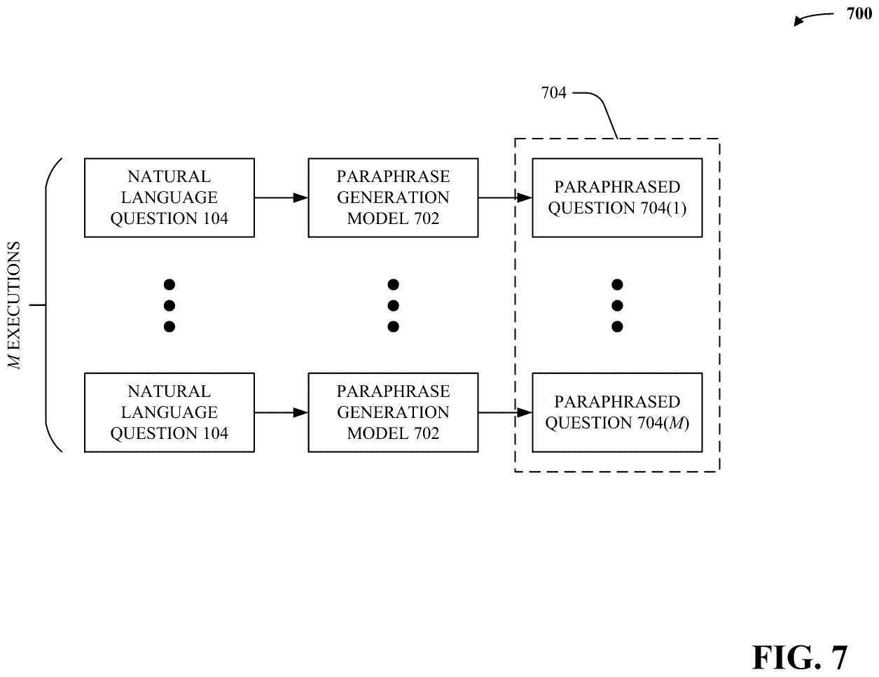

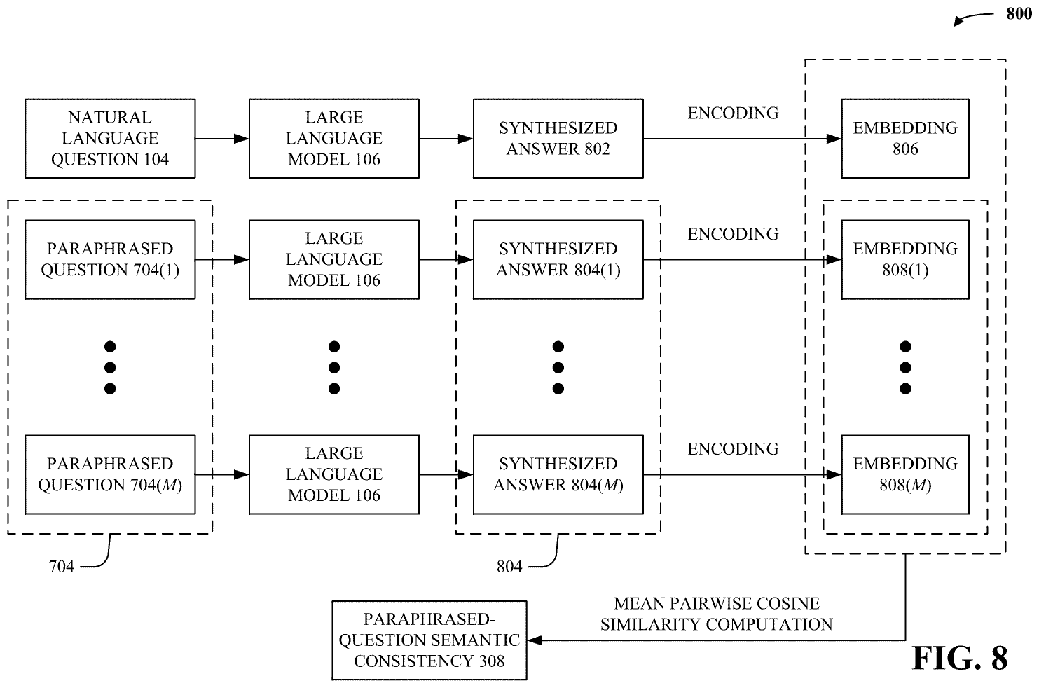

In various aspects, the prediction component 118 can electronically identify the paraphrased-question semantic consistency 308, as described with respect to FIGS. 7-8.

First, consider FIG. 4. FIG. 4 illustrates an example, non-limiting block diagram 400 showing how the semantic category 302 of the natural language question 104 can be determined in accordance with one or more embodiments described herein.

In various embodiments, there can be a semantic category classifier 404. In various aspects, the semantic category classifier 404 can exhibit any suitable deep learning internal architecture. Indeed, in various cases, the semantic category classifier 404 can have an input layer, one or more hidden layers, and an output layer. In various instances, any of such layers can be coupled together by any suitable interneuron connections or interlayer connections (e.g., forward connections, skip connections, recurrent connections). Furthermore, in various cases, any of such layers can be any suitable types of neural network layers having any suitable learnable or trainable internal parameters (e.g., any of such input layer, one or more hidden layers, or output layer can be convolutional layers, dense layers, batch normalization layers, LSTM layers, or transformer layers). Further still, in various cases, any of such layers can be any suitable types of neural network layers having any suitable fixed or non-trainable internal parameters (e.g., any of such input layer, one or more hidden layers, or output layer can be non-linearity layers, padding layers, pooling layers, or concatenation layers).

Regardless of its specific internal architecture, the semantic category classifier 404 can be configured to receive as input a textual question and to determine as output a semantic class or category to which that inputted question belongs. Accordingly, in various instances, the prediction component 118 can electronically execute the semantic category classifier 404 on the natural language question 104, and such execution can cause the semantic category classifier 404 to produce as output a semantic category classification label 406. More specifically, the prediction component 118 can feed the natural language question 104 to an input layer of the semantic category classifier 404, the natural language question 104 can complete a forward pass through one or more hidden layers of the semantic category classifier 404, and an output layer of the semantic category classifier 404 can compute or calculate the semantic category classification label 406 based on activation maps or feature maps produced by the one or more hidden layers of the semantic category classifier 404.

In various aspects, the semantic category classification label 406 can be any suitable electronic data (e.g., can be one or more scalars, one or more vectors, one or more matrices, one or more tensors, one or more character strings, or any suitable combination thereof) that can represent, convey, or otherwise indicate a specific semantic category to which the natural language question 104 belongs (in the opinion of the semantic category classifier 404).

In particular, there can be a plurality of defined semantic categories 402. In various instances, the plurality of defined semantic categories 402 can comprise r categories, for any suitable positive integer r>1: a defined semantic category 402(1) to a defined semantic category 402 (r). In various cases, each of the plurality of defined semantic categories 402 can be or otherwise represent a distinct or unique semantic or substantive topic to which the natural language question 104 might potentially pertain. As some non-limiting examples, the plurality of defined semantic categories 402 can include: an author category (e.g., a class of questions that ask who authored certain literary works or that ask what literary works were authored by certain people); a capital category (e.g., a class of questions that ask for the capitals of certain states, territories, or countries, or that ask for which states, territories, or countries contain certain capitals); a composer category (e.g., a class of questions that ask who composed certain musical works or that ask what musical works were composed by certain people); an occupation class (e.g., a class of questions that ask for the occupation of certain people); or a games class (e.g., a class of questions that ask who plays certain games or that ask what games are played by certain people).

In various aspects, the semantic category classification label 406 can comprise a plurality of probability scores 408. In various instances, the plurality of probability scores 408 can respectively correspond (e.g., in one-to-one fashion) to the plurality of defined semantic categories 402. Thus, since the plurality of defined semantic categories 402 can comprise r categories, the plurality of probability scores 408 can likewise comprise r scores; a probability score 408(1) to a probability score 408 (r). In various cases, each of the plurality of probability scores 408 can be a real-valued scalar that indicates a likelihood (as inferred by the semantic category classifier 404) that the natural language question 104 belongs to a respective one of the plurality of defined semantic categories 402. As a non-limiting example, the probability score 408(1) can be a first scalar estimated by the semantic category classifier 404 and whose value (e.g., ranging from 0 to 1, or from 0% to 100%) indicates a likelihood that the natural language question 104 belongs to the defined semantic category 402(1). As another non-limiting example, the probability score 408 (r) can be an r-th scalar estimated by the semantic category classifier 404 and whose value indicates a likelihood that the natural language question 104 belongs to the defined semantic category 402 (r). Note that the plurality of probability scores 408 can be not independent of each other. As a non-limiting example, the plurality of probability scores 408 can be restricted such that their total sum can be unity (e.g., can be 1 or 100%). In such case, the semantic category classifier 404 can be considered as determining that the natural language question 104 belongs to only one of the plurality of defined semantic categories 402 (e.g., whichever one of the plurality of defined semantic categories 402 has the highest probability score can be considered as being indicated by the semantic category classification label 406). In any case, whichever one of the plurality of defined semantic categories 402 is indicated by the semantic category classification label 406 can be considered as the semantic category 302.

Note that the semantic category 302 can be formatted as a categorical variable rather than a continuous variable.

Now, consider FIG. 5. FIG. 5 illustrates an example, non-limiting block diagram 500 showing how the subject popularity 304 of the natural language question 104 can be determined in accordance with one or more embodiments described herein.

In various embodiments, the natural language question 104 can be considered as a sequence that is made up of a total of p words, for any suitable positive integer p>1: a word 502(1) to a word 502 (p). In various aspects, one or more of those p words can be considered as forming or serving as a verb, action, or predicate of the natural language question 104. In some cases, one or more others of those p words can be considered as forming or serving as a subject of the natural language question 104 (e.g., as a noun or noun phrase that performs the verb). In various instances, that subject can be referred to as a grammatical subject 506. In various cases, the prediction component 118 can automatically identify the grammatical subject 506, by leveraging a named entity recognition model 504.

In various aspects, the named entity recognition model 504 can exhibit any suitable deep learning internal architecture. Indeed, in various cases, the named entity recognition model 504 can have an input layer, one or more hidden layers, and an output layer. In various instances, any of such layers can be coupled together by any suitable interneuron connections or interlayer connections (e.g., forward connections, skip connections, recurrent connections). Furthermore, in various cases, any of such layers can be any suitable types of neural network layers having any suitable learnable or trainable internal parameters (e.g., any of such input layer, one or more hidden layers, or output layer can be convolutional layers, dense layers, batch normalization layers, LSTM layers, or transformer layers). Further still, in various cases, any of such layers can be any suitable types of neural network layers having any suitable fixed or non-trainable internal parameters (e.g., any of such input layer, one or more hidden layers, or output layer can be non-linearity layers, padding layers, pooling layers, or concatenation layers).

Regardless of its specific internal architecture, the named entity recognition model 504 can be configured to receive as input a textual question and to identify as output a subject of that inputted question. Accordingly, in various instances, the prediction component 118 can electronically execute the named entity recognition model 504 on the natural language question 104, and such execution can cause the named entity recognition model 504 to identify as output the grammatical subject 506. More specifically, the prediction component 118 can feed the natural language question 104 to an input layer of the named entity recognition model 504, the natural language question 104 can complete a forward pass through one or more hidden layers of the named entity recognition model 504, and an output layer of the named entity recognition model 504 can compute or calculate an indication of the grammatical subject 506 based on activation maps or feature maps produced by the one or more hidden layers of the named entity recognition model 504.

In various instances, the grammatical subject 506 can correspond to or otherwise be associated with a website 508. In various aspects, the website 508 can be any suitable online or internet-accessible webpage or collection of webpages that describes, explains, provides exposition for, or otherwise is dedicated in whole or in part to the grammatical subject 506. As a non-limiting example, suppose that the natural language question 104 is, “What does Person A do?”. In such case, the named entity recognition model 504 can infer that “Person A” is the grammatical subject 506, and the website 508 can be a Wikipedia® page or Reddit® page that is dedicated to discussing or explaining Person A. As another non-limiting example, suppose that the natural language question 104 is, “When was Event B held?”. In such case, the named entity recognition model 504 can infer that “Event B” is the grammatical subject 506, and the website 508 can be a Wikipedia® page or Reddit® page that is dedicated to discussing or explaining Event B. In various aspects, the prediction component 118 can electronically identify the website 508, by leveraging any suitable web crawler or web browser with respect to the grammatical subject 506. Indeed, the prediction component 118 can electronically instruct, command, or otherwise cause the web crawler or web browser to identify, retrieve, or visit websites that are semantically relevant to, or that have keywords that match, the grammatical subject 506 (e.g., by pasting the grammatical subject 506 into a search bar of the web crawler or web browser). Accordingly, a top- or most-relevant website returned by the web crawler or web browser can be considered as the website 508.

In various aspects, the subject popularity 304 can be a scalar whose value is based on an electronically-recorded amount of interactions received by the website 508. As a non-limiting example, the subject popularity 304 can be equal to or otherwise based on a mean or average number of daily, monthly, or yearly visits or views that the website 508 receives. As another non-limiting example, the subject popularity 304 can be equal to or otherwise based on a mean or average number of daily, monthly, or yearly clicks or comments that the website 508 receives.

Note that the subject popularity 304 can be formatted as a continuous variable rather than a categorical variable.

Furthermore, it should be appreciated that the named entity recognition model 504 need not be limited to identifying or extracting only grammatical subjects. Indeed, in some cases, the named entity recognition model 504 can instead be configured to identify or extract grammatical objects (e.g., subjects perform verbs, whereas objects are acted upon by verbs). In such cases, the grammatical subject 506 can instead be referred to as a “grammatical object 506,” which can be any noun or noun phrase of the natural language question 104 which is acted upon by the verb, action, or predicate of the natural language question 104. It should be understood that, in such cases, the subject popularity 304 can instead be referred to as an “object popularity 304”.

Now, consider FIG. 6. FIG. 6 illustrates an example, non-limiting block diagram 600 showing how the same-question semantic consistency 306 of the natural language question 104 can be determined in accordance with one or more embodiments described herein.

In various embodiments, the LLM 106 can operate either in a greedy decoding mode or a non-greedy decoding mode. While in the greedy decoding mode, the LLM 106 can be considered as synthesizing answers to inputted questions in a deterministic fashion. In particular, the LLM 106 can select which words to insert into its answer to any given question, by assigning dynamic probabilities to all words in its lexicon based on the words of the given question and based on the words it has already inserted into the answer, and by always selecting at each time-step whichever word has a highest dynamic probability. In contrast, while in the non-greedy decoding mode, the LLM 106 can instead be considered as synthesizing answers to inputted questions in a stochastic fashion. In particular, the LLM 106 can select which words to insert into its answer to any given question, by assigning dynamic probabilities to all words in its lexicon based on the words of the given question and based on the words it has already inserted into the answer, and by probabilistically selecting at each time-step one word based on those dynamic probabilities. Thus, while in non-greedy mode, there is a non-zero chance that the LLM 106 does not select the highest-probability word at any given time-step.

Now, in various embodiments, the prediction component 118 can set the LLM 106 to the non-greedy mode and can electronically execute the LLM 106 on the natural language question 104 a total of n times, for any suitable positive integer n>1. Such repeated executions can yield a plurality of synthesized answers 602.

As a non-limiting example, the prediction component 118 can execute the LLM 106 on the natural language question 104 a first time (e.g., the natural language question 104 can complete a first forward pass through the input, hidden, and output layers of the LLM 106). This can cause the LLM 106 to produce a synthesized answer 602(1), which can be one or more first plain text declarative sentences or sentence fragments that (in the opinion of the LLM 106) substantively respond to the natural language question 104. Note that it is possible for the synthesized answer 602(1) to be factually wrong or incorrect.

As another non-limiting example, the prediction component 118 can execute the LLM 106 on the natural language question 104 an n-th time (e.g., the natural language question 104 can complete an n-th forward pass through the input, hidden, and output layers of the LLM 106). This can cause the LLM 106 to produce a synthesized answer 602(n), which can be one or more n-th plain text declarative sentences or sentence fragments that (in the opinion of the LLM 106) substantively respond to the natural language question 104. As above, note that it is possible for the synthesized answer 602(n) to be factually wrong or incorrect.

In various cases, the synthesized answer 602(1) to the synthesized answer 602(n) can collectively be considered as the plurality of synthesized answers 602. Note that, because the LLM 106 can be executed in non-greedy mode, any two of the plurality of synthesized answers 602 can comprise the same or different words than each other.

In various embodiments, the prediction component 118 can electronically generate a plurality of embeddings 604 that respectively correspond (e.g., in one-to-one fashion) to the plurality of synthesized answers 602. As a non-limiting example, the prediction component 118 can apply any suitable word-to-vector or sentence-to-vector encoding techniques (e.g., the encoder portion 108, Word2Vec, GloVe, FastText, ELMo, BERT, Skip-Though Vectors, InferSent) to the synthesized answer 602(1), and such application can produce an embedding 604(1) (e.g., a latent vector that numerically represents the synthesized answer 602(1)). As another non-limiting example, the prediction component 118 can apply any suitable word-to-vector or sentence-to-vector encoding techniques to the synthesized answer 602(n), and such application can produce an embedding 604 (n) (e.g., a latent vector that numerically represents the synthesized answer 602(n)).

In various cases, the embedding 604(1) to the embedding 604 (n) can collectively be considered as the plurality of embeddings 604. In various instances, all of the plurality of embeddings 604 can have the same format, size, or dimensionality as each other.

In various aspects, the prediction component 118 can electronically compute the same-question semantic consistency 306 based on the plurality of embeddings 604. In particular, the same-question semantic consistency 306 can be a scalar whose value is equal to or otherwise based on a mean pairwise cosine similarity of the plurality of embeddings 604. Formally, the same-question semantic consistency 306 can be equal to or otherwise based on the following expression:

$$\frac{1}{( \begin{matrix}\vert {S}_{1} \vert \\ 2\end{matrix} )} {\sum }_{i = 1}^{\vert {S}_{1} \vert - 1} {\sum }_{j = i + 1}^{\vert {S}_{1} \vert} cosine ( {e}_{i} , {e}_{j} )$$

where S₁ can be the plurality of synthesized answers 602, where i and j can be summation indices, where eᵢ and eⱼ can respectively be the i-th and j-th ones of the plurality of embeddings 604, and where cosine (eᵢ, eⱼ) can be the cosine of the angle between eᵢ and eⱼ.

Note that the same-question semantic consistency 306 can be formatted as a continuous variable rather than a categorical variable.

Next, consider FIGS. 7-8. FIGS. 7-8 illustrate example, non-limiting block diagrams 700 and 800 showing how the paraphrased-question semantic consistency 308 of the natural language question 104 can be determined in accordance with one or more embodiments described herein.

First, consider FIG. 7. In various embodiments, the prediction component 118 can electronically generate a plurality of paraphrased questions 704 corresponding to the natural language question 104, by leveraging a paraphrase generation model 702. In various aspects, the paraphrase generation model 702 can exhibit any suitable deep learning internal architecture. Indeed, in various cases, the paraphrase generation model 702 can have an input layer, one or more hidden layers, and an output layer. In various instances, any of such layers can be coupled together by any suitable interneuron connections or interlayer connections (e.g., forward connections, skip connections, recurrent connections). Furthermore, in various cases, any of such layers can be any suitable types of neural network layers having any suitable learnable or trainable internal parameters (e.g., any of such input layer, one or more hidden layers, or output layer can be convolutional layers, dense layers, batch normalization layers, LSTM layers, or transformer layers). Further still, in various cases, any of such layers can be any suitable types of neural network layers having any suitable fixed or non-trainable internal parameters (e.g., any of such input layer, one or more hidden layers, or output layer can be non-linearity layers, padding layers, pooling layers, or concatenation layers).

Regardless of its specific internal architecture, the paraphrase generation model 702 can be configured to receive as input a textual question and to produce as output a paraphrase of that inputted question. Accordingly, in various instances, the prediction component 118 can electronically execute the paraphrase generation model 702 (e.g., in non-greedy mode) on the natural language question 104 a total of m times, for any suitable positive integer m>1, and such executions can yield the plurality of paraphrased questions 704.

As a non-limiting example, the prediction component 118 can execute the paraphrase generation model 702 on the natural language question 104 a first time (e.g., the natural language question 104 can complete a first forward pass through the input, hidden, and output layers of the paraphrase generation model 702). This can cause the paraphrase generation model 702 to produce a paraphrased question 704(1), which can be one or more first plain text sentences or sentence fragments that (in the opinion of the paraphrase generation model 702) are non-identical and yet semantically equivalent to the natural language question 104. That is, the paraphrased question 704(1) can be a first reworded version of the natural language question 104 (e.g., if the natural language question 104 is “What is Person A's occupation?”, the paraphrased question 704(1) can be “What is Person A's job?”).

As another non-limiting example, the prediction component 118 can execute the paraphrase generation model 702 on the natural language question 104 an m-th time (e.g., the natural language question 104 can complete an m-th forward pass through the input, hidden, and output layers of the paraphrase generation model 702). This can cause the paraphrase generation model 702 to produce a paraphrased question 704(m), which can be one or more m-th plain text sentences or sentence fragments that (in the opinion of the paraphrase generation model 702) are non-identical and yet semantically equivalent to the natural language question 104. That is, the paraphrased question 704(m) can be an m-th reworded version of the natural language question 104 (e.g., if the natural language question 104 is “What is Person A's occupation?”, the paraphrased question 704(m) can be “How does Person A earn a living?”).

In various cases, the paraphrased question 704(1) to the paraphrased question 704(m) can collectively be considered as the plurality of paraphrased questions 704.

It should be appreciated and understood that the prediction component 118 can generate the plurality of paraphrased questions 704 in any other suitable fashion. As a non-limiting example, there can be m distinct or unique paraphrase templates, with each template being a pre-made question having one or more empty or blank text fields that are flagged to be filled with respective grammatical components (e.g., a blank verb field that is flagged to be filled with a verb, a blank subject field that is flagged to be filled with a subject, a blank object field that is flagged to be filled with an object). In such cases, the prediction component 118 can identify (e.g., via execution of the named entity recognition model 504) different grammatical components (e.g., verbs, subjects, objects) of the natural language question 104 and can insert or paste those grammatical components into associated or respective blank text fields of those m templates. Once the blank text fields are filled, those m templates can be considered as the plurality of paraphrased questions 704.

Now, consider FIG. 8. In various embodiments, the prediction component 118 can electronically execute the LLM 106 (e.g., either in greedy or non-greedy mode) on the natural language question 104. This can cause the LLM 106 to produce a synthesized answer 802, which can be one or more plain text declarative sentences or sentence fragments that (in the opinion of the LLM 106) substantively respond to the natural language question 104. As above, note that it is possible for the synthesized answer 802 to be factually wrong or incorrect.

Furthermore, in various aspects, the prediction component 118 can electronically execute the LLM 106 (e.g., either in greedy or non-greedy mode) on each of the plurality of paraphrased questions 704, thereby yielding a plurality of synthesized answers 804.

As a non-limiting example, the prediction component 118 can execute the LLM 106 on the paraphrased question 704(1) (e.g., the paraphrased question 704(1) can complete a forward pass through the input, hidden, and output layers of the LLM 106). This can cause the LLM 106 to produce a synthesized answer 804(1), which can be one or more plain text declarative sentences or sentence fragments that (in the opinion of the LLM 106) substantively respond to the paraphrased question 704(1). Note that it is possible for the synthesized answer 804(1) to be factually wrong or incorrect.

As another non-limiting example, the prediction component 118 can execute the LLM 106 on the paraphrased question 704(m) (e.g., the paraphrased question 704(m) can complete a forward pass through the input, hidden, and output layers of the LLM 106). This can cause the LLM 106 to produce a synthesized answer 804(m), which can be one or more plain text declarative sentences or sentence fragments that (in the opinion of the LLM 106) substantively respond to the paraphrased question 704(m). Again, note that it is possible for the synthesized answer 804(m) to be factually wrong or incorrect.

In various cases, the synthesized answer 804(1) to the synthesized answer 804(m) can collectively be considered as the plurality of synthesized answers 804.

In various aspects, the prediction component 118 can electronically generate (as described above) an embedding 806 for the synthesized answer 802. Likewise, the prediction component 118 can, in various instances, electronically generate (as described above) a plurality of embeddings 808 that respectively correspond (e.g., in one-to-one fashion) to the plurality of synthesized answers 804 (e.g., an embedding 808(1) can be a latent vector that numerically represents the synthesized answer 804(1); an embedding 808(m) can be a latent vector that numerically represents the synthesized answer 804(m)).

In various aspects, the prediction component 118 can electronically compute the paraphrased-question semantic consistency 308 based on the embedding 806 and based on the plurality of embeddings 808. Indeed, just as described above, the paraphrased-question semantic consistency 308 can be a scalar whose value is equal to or otherwise based on a mean pairwise cosine similarity of the embedding 806 and of the plurality of embeddings 808. Formally, the paraphrased-question semantic consistency 308 can be equal to or otherwise based on the following expression:

$$\frac{1}{( \begin{matrix}\vert {S}_{2} \vert \\ 2\end{matrix} )} {\sum }_{i = 1}^{\vert {S}_{2} \vert - 1} {\sum }_{j = i + 1}^{\vert {S}_{2} \vert} cosine ( {e}_{i} , {e}_{j} )$$

where S₂ can be the union of the synthesized answer 802 and the plurality of synthesized answers 804, where i and j can be summation indices, and where eᵢ and eⱼ can respectively be the i-th and j-th ones of union of the embedding 806 and the plurality of embeddings 808, and where cosine (eᵢ, eⱼ) can be the cosine of the angle between eᵢ and eⱼ.

Note that the paraphrased-question semantic consistency 308 can be formatted as a continuous variable rather than a categorical variable.

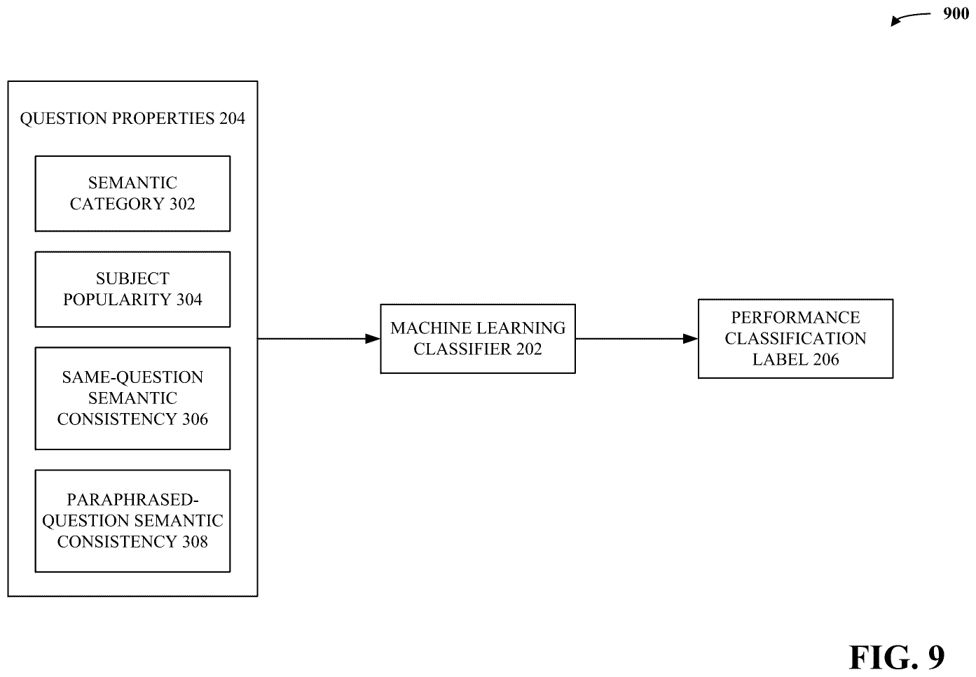

FIG. 9 illustrates an example, non-limiting block diagram 900 showing how the performance classification label 206 can be generated in accordance with one or more embodiments described herein.

In various embodiments, the prediction component 118 can electronically generate the performance classification label 206, by executing the machine learning classifier 202 on the set of question properties 204. As a non-limiting example, suppose that the machine learning classifier 202 exhibits a deep learning internal architecture. In such case, the set of question properties 204 can complete a forward pass through the input, hidden, and output layers of the machine learning classifier 202, which can cause the machine learning classifier 202 to produce the performance classification label 206. As another non-limiting example, suppose that the machine learning classifier 202 instead exhibits a logistic regression architecture. In such case, the set of question properties 204 can be considered as the regressors of the machine learning classifier 202, and the performance classification label 206 can be equal to or otherwise based on a weighted linear combination of the set of question properties 204 (e.g., for first-order regressor interactions) or of respective products of the set of question properties 204 (e.g., for higher-order regressor interactions), where the weights of such weighted linear combination can be the learned parameters of the machine learning classifier 202. In particular, respective first-order coefficients can be learned for: the semantic category 302; the natural logarithm of the subject popularity 304; the same-question semantic consistency 306; and the paraphrased-question semantic consistency 308. Additionally, respective second-order coefficients can be learned for: interactions between the semantic category 302 and the natural logarithm of the subject popularity 304; interactions between the semantic category 302 and the same-question semantic consistency 306; and interactions between the semantic category 302 and the paraphrased-question semantic consistency 308. It should be appreciated and understood that, because the semantic category 302 is a categorical variable, it can be implemented or expressed in logistic regression using dummy values.

In various aspects, the performance classification label 206 can be any suitable electronic data (e.g., one or more scalars, one or more vectors, one or more matrices, one or more tensors, one or more character strings, or any suitable combination thereof) that can binarily or dichotomously indicate either: that the LLM 106 will or is likely to correctly answer the natural language question 104; or that the LLM 106 will or is likely to incorrectly answer the natural language question 104. As a non-limiting example, the performance classification label 206 can be a scalar whose value, which can range between 0 and 1, indicates a probability that the LLM 106 will correctly answer the natural language question 104. Thus, scalar values below 0.5 (or any other suitable threshold) can be interpreted to mean that the LLM will or is likely to incorrectly answer the natural language question 104, whereas scalar values above 0.5 (or any other suitable threshold) can be interpreted to mean that the LLM will or is likely to correctly answer the natural language question 104.

In any case, the set of question properties 204 can be considered as valuable or rich metadata that possesses predictive or correlative power with respect to the ability of the LLM 106 to correctly answer the natural language question 104. Indeed, it is possible that the LLM 106 possesses a type of subject matter expertise, such that it is more likely to correctly or accurately answer questions that belong to certain semantic categories than to others. Likewise, it is possible that the LLM 106 encounters more frequently questions that pertain to popular topics than to unpopular topics, meaning that the LLM 106 can be more likely to correctly answer such popular questions. Similarly, if the LLM 106, when operating in non-greedy mode, exhibits significant answer variance when executed multiple times on the same question, this can be interpreted to mean that the LLM 106 is not certain or confident about its answers to that question. Relatedly, if the LLM 106, when operating in non-greedy mode or in greedy mode, exhibits significant answer variance when executed on paraphrases of a given question, this can be interpreted to mean that the LLM 106 is distracted by semantically-irrelevant details of the given question, thereby warranting less confidence in its answers to that given question. Accordingly, by feeding the set of question properties 204 as input to the machine learning classifier 202, the machine learning classifier 202 can be able to accurately or confidently predict whether or not the LLM 106 will or is likely to generate a correct answer to the natural language question 104. Existing techniques do not feed such properties as input to a machine learning classifier.

In various embodiments, the action component 120 of the performance prediction system 102 can electronically transmit the performance classification label 206 to any suitable computing device, or can electronically render the performance classification label 206 on any suitable electronic display. Accordingly, whatever user that provided or asked the natural language question 104 can be alerted to the performance classification label 206 and can thus know whether or not to trust the LLM 106 to answer the natural language question 104.

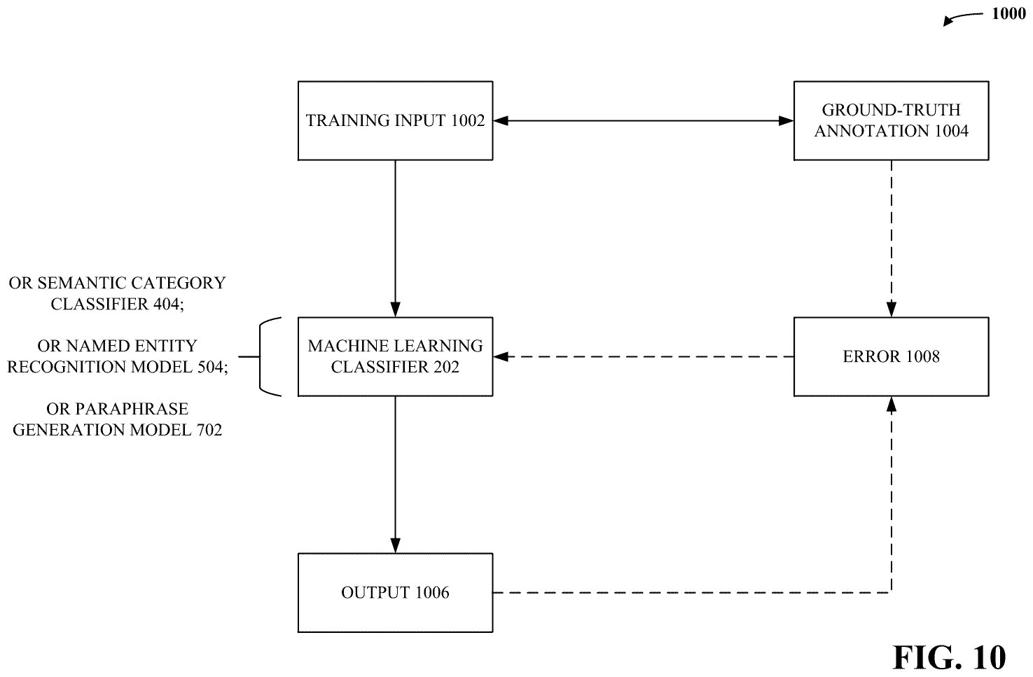

In order for the performance classification label 206 to be accurate or reliable, the various machine learning models described herein can first undergo training. A non-limiting example of such training is described with respect to FIG. 10.

FIG. 10 illustrates an example, non-limiting block diagram 1000 showing how various artificial intelligence models can be trained in accordance with one or more embodiments described herein.

In various aspects, prior to beginning training, the trainable internal parameters (e.g., convolutional kernels, weight matrices, bias values, regression coefficients) of whatever artificial intelligence model is being trained (e.g., the machine learning classifier 202, the semantic category classifier 404, the named entity recognition model 504, the paraphrase generation model 702) can be initialized in any suitable fashion (e.g., via random initialization).

In various embodiments, there can be a training input 1002 and a ground-truth annotation 1004. When it is desired to train the machine learning classifier 202, the training input 1002 can be any suitable set of training question properties (e.g., a semantic category of a training question, a subject popularity of the training question, a same-question semantic consistency of the training question, or a paraphrased-question semantic consistency of the training question), and the ground-truth annotation 1004 can be whatever correct or accurate performance classification label is known or deemed to correspond to the training input 1002. When it is desired to train the semantic category classifier 404, the training input 1002 can be any suitable training question, and the ground-truth annotation 1004 can be whatever correct or accurate semantic category classification label is known or deemed to correspond to the training input 1002. When it is desired to train the named entity recognition model 504, the training input 1002 can be any suitable training question, and the ground-truth annotation 1004 can be whatever correct or accurate grammatical subject or grammatical object is known or deemed to correspond to the training input 1002. When it is desired to train the paraphrase generation model 702, the training input 1002 can be any suitable training question, and the ground-truth annotation 1004 can be whatever correct or accurate paraphrase is known or deemed to correspond to the training input 1002.

In any case, the artificial intelligence model that is being trained can be executed on the training input 1002, thereby causing that artificial intelligence model to produce an output 1006. Note that the format, size, or dimensionality of the output 1006 can be dictated by the number, arrangement, sizes, or other characteristics of the neurons, convolutional kernels, LSTM layers, regressor coefficients, or other internal parameters of the artificial intelligence model. Accordingly, the output 1006 can be forced to have any desired format, size, or dimensionality, by adding, removing, or otherwise adjusting characteristics of the internal parameters of the artificial intelligence model.

In various aspects, if the output 1006 is produced by the machine learning classifier 202, the output 1006 can be considered as the predicted or inferred performance classification label that the machine learning classifier 202 believes should correspond to the training input 1002. If the output 1006 is produced by the semantic category classifier 404, the output 1006 can be considered as the predicted or inferred semantic category classification label that the semantic category classifier 404 believes should correspond to the training input 1002. If the output 1006 is produced by the named entity recognition model 504, the output 1006 can be considered as the predicted or inferred grammatical subject or object that the named entity recognition model 504 believes should correspond to the training input 1002. If the output 1006 is produced by the paraphrase generation model 702, the output 1006 can be considered as the predicted or inferred paraphrase that the paraphrase generation model 702 believes should correspond to the training input 1002. In any case, note that, if the artificial intelligence model that is being trained has so far undergone no or little training, then the output 1006 can be highly inaccurate (e.g., can be very different from the ground-truth annotation 1004).

In various aspects, an error 1008 (e.g., mean absolute error, mean squared error, cross-entropy error) between the output 1006 and the ground-truth annotation 1004 can be computed. In various instances, the trainable internal parameters of the artificial intelligence model can be incrementally updated via backpropagation (e.g., stochastic gradient descent) based on the error 1008.

In various cases, such execution-and-update procedure can be repeated for any suitable number of input-annotation pairs. This can ultimately cause the trainable internal parameters of the artificial intelligence model (e.g., of the machine learning classifier 202, of the semantic category classifier 404, of the named entity recognition model 504, of the paraphrase generation model 702) to become iteratively optimized for accurately performing its inferencing task (e.g., generative question-answering performance classification, semantic category classification, named entity recognition, paraphrase generation). In various aspects, any suitable training batch sizes, any suitable error/loss functions, or any suitable training termination criteria can be utilized during such training.

Although the herein disclosure mainly describes the various artificial intelligence models as being trained in supervised fashion, this is a mere non-limiting example for case of explanation and illustration. In various embodiments, any other suitable training paradigms can be used to train any of such artificial intelligence models, such as unsupervised training or reinforcement learning, any of which may be federated or non-federated.

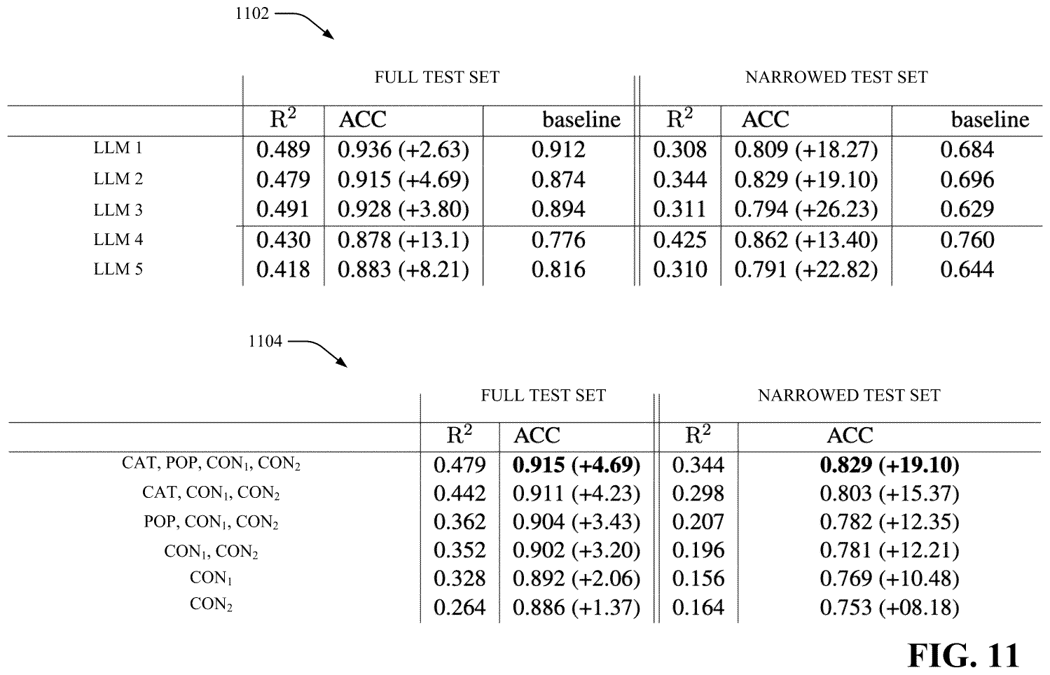

The present inventors conducted various experiments to validate technical benefits or technical effects of various embodiments described herein, as shown in FIG. 11.

Consider a table 1102. For five distinct LLMs (labeled 1 through 5) and for an available dataset of factual questions, a respective embodiment described herein was reduced to practice. That is, a first embodiment was created to predict the question-answering performance of the LLM 1; a second embodiment was created to predict the question-answering performance of the LLM 2; a third embodiment was created to predict the question-answering performance of the LLM 3; a fourth embodiment was created to predict the question-answering performance of the LLM 4; and a fifth embodiment was created to predict the question-answering performance of the LLM 5. In each of such embodiments, the machine learning classifier 202 was structured as a logistic regression model, and the set of question properties 204 included all of the semantic category 302, the subject popularity 304, the same-question semantic consistency 306, and the paraphrased-question semantic consistency 308. The table 1102 shows McFadden's pseudo-R² scores, prediction accuracy (denoted “ACC”), and naïve baseline accuracy (denoted “baseline”) for each embodiment for both the full dataset and for a respective narrowed version of the full dataset.

For clarification, consider the first embodiment which was configured to predict the question-answering performance of the LLM 1. When executed on the full dataset, the LLM 1 correctly answered only about 8.8% of the inputted natural language questions correctly (the full dataset was considered as very difficult). Accordingly, a naïve baseline classifier (which would always predict that the LLM 1 would generate an incorrect answer) would achieve a prediction accuracy rate of about 91.2% (e.g., complement of 8.8%). In other words, the naïve baseline classifier would correctly predict the performance of the LLM 1 for 91.2% of the questions in the full dataset. Now, as shown, the first embodiment with respect to the full dataset achieved a McFadden's pseudo-R² score of 0.489, which indicates very good fit (since a good fit threshold is often taken as 0.2). Additionally, as shown, the first embodiment with respect to the full dataset achieved a prediction accuracy rate of about 93.6%. In other words, the first embodiment was able to correctly predict the performance of the LLM 1 for 93.6% of the questions in the full dataset, which was about 2.63 percentage points better than the naïve baseline. Furthermore, a narrowed version of the full dataset was taken, where that narrowed version included only semantic categories for which the LLM 1 achieved an accuracy rate of at least 10%. When executed on that narrowed dataset, the LLM 1 correctly answered about 31.6% of the inputted natural language questions correctly, meaning that a naïve baseline classifier would achieve a prediction accuracy rate of 68.4% (e.g., complement of 31.6%). As shown, the first embodiment with respect to the narrowed dataset achieved a McFadden's pseudo-R² score of 0.308, which still indicates very good fit. Additionally, as shown, the first embodiment with respect to the narrowed dataset achieved a prediction accuracy rate of about 80.9%, which was about 18.27 percentage points better than the naïve baseline.

As table 1102 shows, all embodiments that were reduced to practice (e.g., for all five of the tested LLMs) significantly outperformed the naïve baseline classifier, thereby demonstrating that such embodiments constitute a technical benefit or technical effect.

Next, consider the table 1104. The present inventors conducted an ablation study for the second embodiment that was configured to predict the question-answering accuracy of the LLM 2. In that ablation study, six different versions of that second embodiment were reduced to practice: a first version that received as input all of the semantic category 302 (denoted “CAT”), the subject popularity 304 (denoted “POP”), the same-question semantic consistency 306 (denoted “CON₁”), and the paraphrased-question semantic consistency 308 (denoted “CON₂”); a second version that receive as input only the semantic category 302, the same-question semantic consistency 306, and the paraphrased-question semantic consistency 308; a third version that received as input only the subject popularity 304, the same-question semantic consistency 306, and the paraphrased-question semantic consistency 308; a fourth version that received as input only the same-question semantic consistency 306 and the paraphrased-question semantic consistency 308; a fifth version that received as input only the same-question semantic consistency 306; and a sixth version that received as input only the paraphrased-question semantic consistency 308. For each of those six versions, McFadden's pseudo-R² score, prediction accuracy, and percentage-point change with respect to naïve baseline (shown in parentheses) were computed for both the full dataset and for a respective narrowed version of the full dataset (e.g., narrowed to include only semantic categories for which the LLM 2 achieved an accuracy rate of at least 10%). As shown, all embodiments outperformed the naïve baseline, even as the set of question properties 204 were reduced or pruned. Again, this demonstrates that various embodiments described herein constitute a concrete and tangible improvement or practical application in the field of generative question-answering.

In particular, table 1104 demonstrates that powerful or reliable prediction of an LLM's ability to correctly answer a given question can be achieved without resorting or otherwise referring to extrinsic information regarding the given question. Indeed, for any given question and LLM, the same-question semantic consistency (e.g., 306, CON₁) and the paraphrased-question semantic consistency (e.g., 308, CON₂) for that given question can, in some cases, be considered as always-obtainable or always-available intrinsic information (e.g., can always be obtained by repeatedly executing the LLM non-greedily on the given question or on paraphrases thereof). In contrast, the semantic category (e.g., 302, CAT) and the subject popularity (e.g., 304, POP) of the given question can, in some instances, be considered as not-always-obtainable or not-always-available extrinsic information (e.g., discrete semantic categories might not be extrinsically defined; a corresponding extrinsic website might not be available). But, as table 1104 shows, even when such extrinsic information (e.g., semantic category and subject popularity) is omitted, better-than-baseline prediction of an LLM's ability to correctly answer the given question can nevertheless be achieved. In other words, table 1104 helps to demonstrate that powerful prediction accuracy can be achieved using any suitable combination of semantic category, subject popularity, same-question semantic consistency, or paraphrased-question semantic consistency.

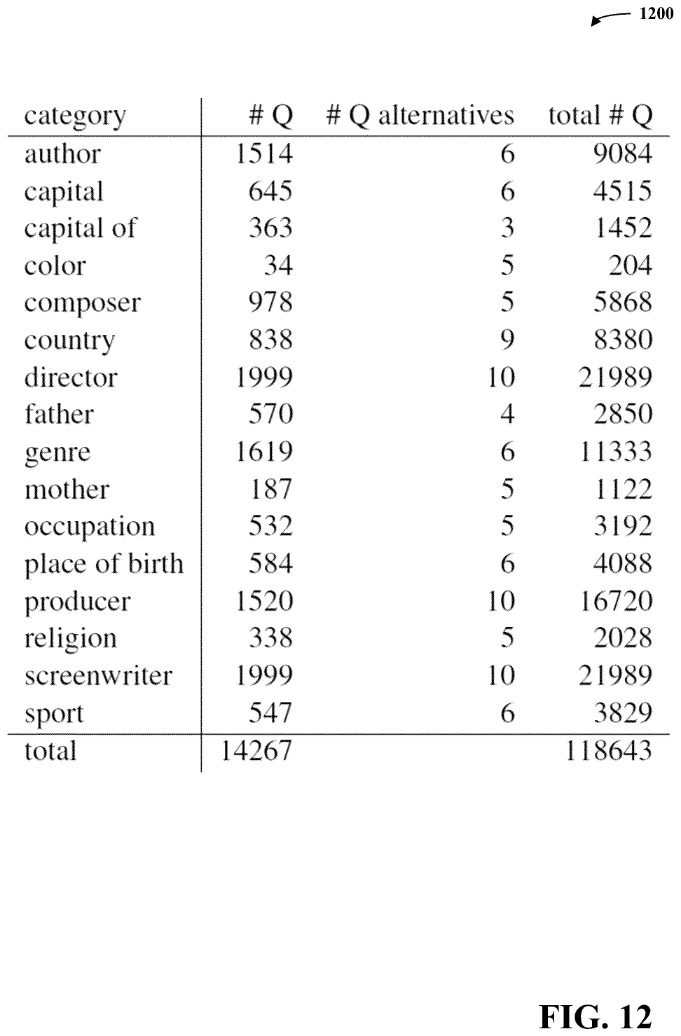

FIG. 12 illustrates an example, non-limiting table 1200 in accordance with one or more embodiments described herein.

In particular, the table 1200 shows the breakdown or composition of the total dataset that was used to facilitate the above-mentioned experiments. Specifically, the total dataset was the union of: an initial dataset of natural language questions; and one or more paraphrases for each natural language question in the initial dataset. Each natural language question in the initial dataset belonged to a respective one of sixteen semantic categories, as shown in the table 1200 in a column labeled “category”. The table 1200 shows, in a column labeled “#Q”, how many natural language questions in the initial dataset belonged to each respective semantic category. Additionally, the table 1200 shows, in a column labeled “#Q alternatives”, how many paraphrases were generated (e.g., via template techniques) for each natural language question belonging to each semantic category. Lastly, the table 1200 shows, in a column labeled “total #Q”, how many total natural language questions there were in each semantic category after such paraphrase generation. To perform the above-mentioned experiments, 80% of the total dataset was used for training (e.g., of the machine learning classifier 202), and the remaining 20% of the total dataset was used for testing or validation (e.g., to generate the table 1102 and the table 1104).

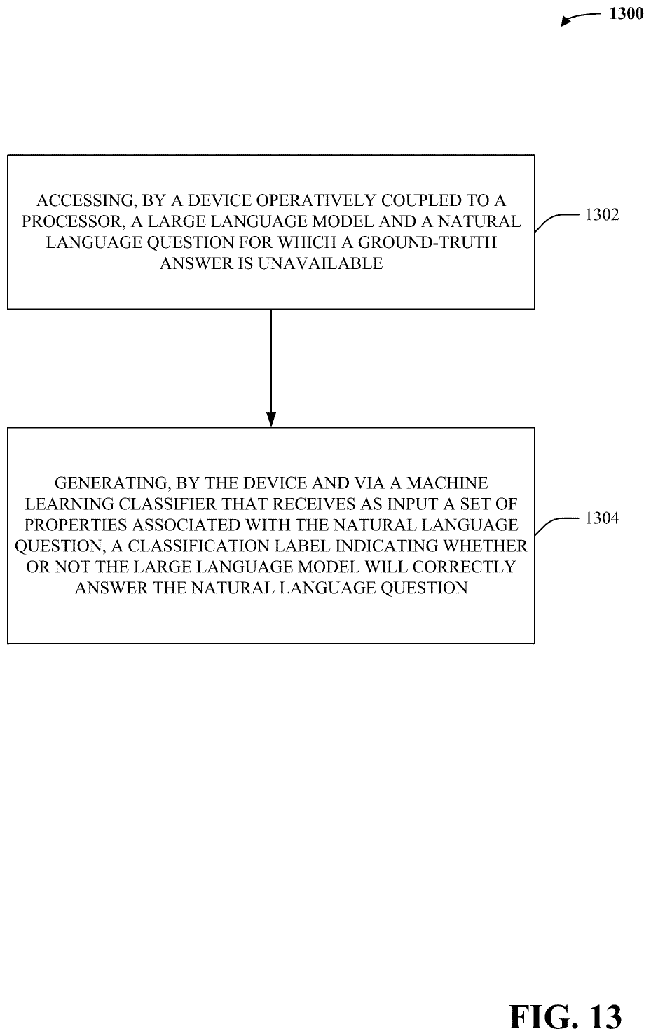

FIG. 13 illustrates a flow diagram of an example, non-limiting computer-implemented method 1300 that can facilitate ground-truth-less performance prediction of generative question-answering systems in accordance with one or more embodiments described herein. In various cases, the performance prediction system 102 can facilitate the computer-implemented method 1300.

In various embodiments, act 1302 can include accessing, by a device (e.g., via 116) operatively coupled to a processor (e.g., 112), a large language model (e.g., 106) and a natural language question (e.g., 104) for which a ground-truth answer is unavailable.

In various aspects, act 1304 can include generating, by the device (e.g., via 118) and via a machine learning classifier (e.g., 202) that receives as input a set of properties (e.g., 204) associated with the natural language question, a classification label (e.g., 206) indicating whether or not the large language model will correctly answer the natural language question.

Although not explicitly shown in FIG. 13, the machine learning classifier can be a logistic regression model.

Although not explicitly shown in FIG. 13, the set of properties can comprise a continuous variable indicating an amount of popularity (e.g., 304) of a grammatical subject or grammatical object (e.g., 506) of the natural language question, wherein the grammatical subject or the grammatical object can be identified via named-entity recognition. In various cases, the grammatical subject or the grammatical object of the natural language question can correspond to a website (e.g., 508), and the continuous variable can be based on a number of monthly views of the website.

Although not explicitly shown in FIG. 13, the device can execute the large language model on the natural language question a plurality of times (e.g., n times) using a non-greedy decoding mode of the large language model, thereby yielding a plurality of synthesized answers (e.g., 602), and the set of properties can comprise a continuous variable indicating a semantic consistency (e.g., 306) of the plurality of synthesized answers. In various cases, the semantic consistency can be based on a mean pairwise cosine similarity of embeddings (e.g., 604) of the plurality of synthesized answers.

Although not explicitly shown in FIG. 13, the device can execute the large language model on the natural language question and on a plurality of paraphrases (e.g., 704) of the natural language question, thereby yielding a plurality of synthesized answers (e.g., 802 and 804), and the set of properties can comprise a continuous variable indicating a semantic consistency (e.g., 308) of the plurality of synthesized answers.

Although not explicitly shown, the set of properties can comprise a categorical variable indicating a semantic category (e.g., 302) to which the natural language question belongs.

Although the herein disclosure mainly describes various embodiments as applying to factual or factoid questions, these are mere non-limiting examples for ease of explanation. In various embodiments, the herein-described teachings can be applied or extrapolated to any suitable type of natural language question that is answerable by an LLM (e.g., not limited only to factual or factoid questions).

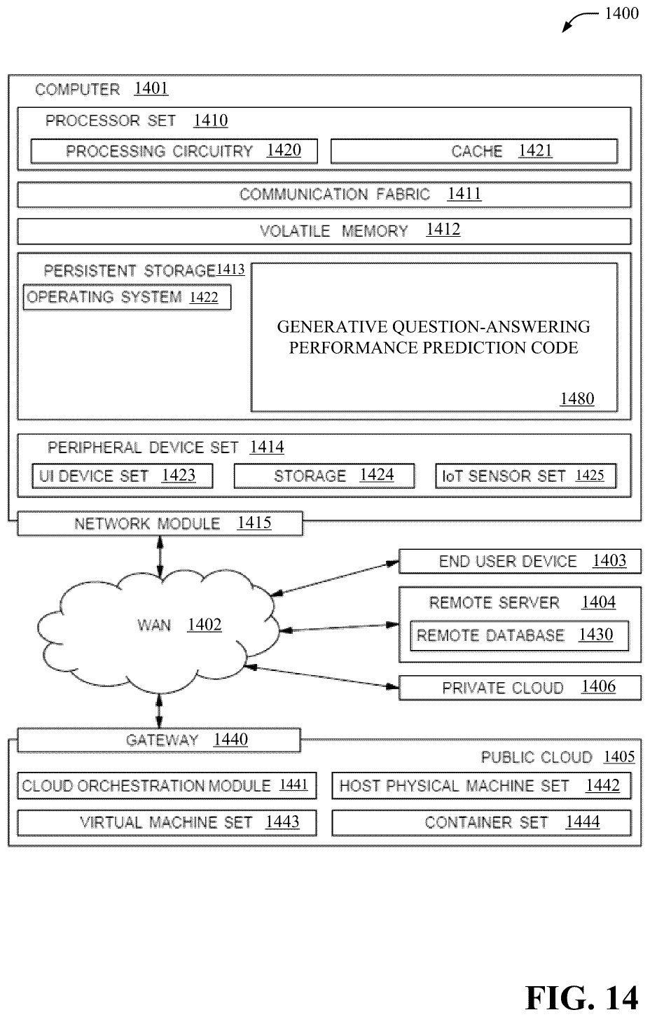

FIG. 14 and the following discussion are intended to provide a brief, general description of a suitable computing environment 1400 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1400 contains an example of an environment for the execution of at least some of the computer code involved in performing the inventive methods, such as generative question-answering performance prediction code 1480. In addition to block 1480, computing environment 1400 includes, for example, computer 1401, wide area network (WAN) 1402, end user device (EUD) 1403, remote server 1404, public cloud 1405, and private cloud 1406. In this embodiment, computer 1401 includes processor set 1410 (including processing circuitry 1420 and cache 1421), communication fabric 1411, volatile memory 1412, persistent storage 1413 (including operating system 1422 and block 1480, as identified above), peripheral device set 1414 (including user interface (UI), device set 1423, storage 1424, and Internet of Things (IoT) sensor set 1425), and network module 1415. Remote server 1404 includes remote database 1430. Public cloud 1405 includes gateway 1440, cloud orchestration module 1441, host physical machine set 1442, virtual machine set 1443, and container set 1444.

COMPUTER 1401 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1430. As is well understood in the art of computer technology, and depending upon the technology, performance of a computer-implemented method can be distributed among multiple computers or between multiple locations. On the other hand, in this presentation of computing environment 1400, detailed discussion is focused on a single computer, specifically computer 1401, to keep the presentation as simple as possible. Computer 1401 can be located in a cloud, even though it is not shown in a cloud in FIG. 14. On the other hand, computer 1401 is not required to be in a cloud except to any extent as can be affirmatively indicated.

PROCESSOR SET 1410 includes one, or more, computer processors of any type now known or to be developed in the future. Processing circuitry 1420 can be distributed over multiple packages, for example, multiple, coordinated integrated circuit chips. Processing circuitry 1420 can implement multiple processor threads or multiple processor cores. Cache 1421 is memory that is located in the processor chip package(s) and is typically used for data or code that should be available for rapid access by the threads or cores running on processor set 1410. Cache memories are typically organized into multiple levels depending upon relative proximity to the processing circuitry. Alternatively, some, or all, of the cache for the processor set can be located “off chip.” In some computing environments, processor set 1410 can be designed for working with qubits and performing quantum computing.

Computer readable program instructions are typically loaded onto computer 1401 to cause a series of operational steps to be performed by processor set 1410 of computer 1401 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 1421 and the other storage media discussed below. The program instructions, and associated data, are accessed by processor set 1410 to control and direct performance of the inventive methods. In computing environment 1400, at least some of the instructions for performing the inventive methods can be stored in block 1480 in persistent storage 1413.

COMMUNICATION FABRIC 1411 is the signal conduction path that allows the various components of computer 1401 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 1412 is any type of volatile memory now known or to be developed in the future. Examples include dynamic type random access memory (RAM) or static type RAM. Typically, the volatile memory is characterized by random access, but this is not required unless affirmatively indicated. In computer 1401, the volatile memory 1412 is located in a single package and is internal to computer 1401, but, alternatively or additionally, the volatile memory can be distributed over multiple packages or located externally with respect to computer 1401.

PERSISTENT STORAGE 1413 is any form of non-volatile storage for computers that is now known or to be developed in the future. The non-volatility of this storage means that the stored data is maintained regardless of whether power is being supplied to computer 1401 or directly to persistent storage 1413. Persistent storage 1413 can be a read only memory (ROM), but typically at least a portion of the persistent storage allows writing of data, deletion of data and re-writing of data. Some familiar forms of persistent storage include magnetic disks and solid-state storage devices. Operating system 1422 can take several forms, such as various known proprietary operating systems or open-source Portable Operating System Interface type operating systems that employ a kernel. The code included in block 1480 typically includes at least some of the computer code involved in performing the inventive methods.

PERIPHERAL DEVICE SET 1414 includes the set of peripheral devices of computer 1401. Data communication connections between the peripheral devices and the other components of computer 1401 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1423 can include components such as a display screen, speaker, microphone, wearable devices (such as goggles and smart watches), keyboard, mouse, printer, touchpad, game controllers, and haptic devices. Storage 1424 is external storage, such as an external hard drive, or insertable storage, such as an SD card. Storage 1424 can be persistent or volatile. In some embodiments, storage 1424 can take the form of a quantum computing storage device for storing data in the form of qubits. In embodiments where computer 1401 is required to have a large amount of storage (for example, where computer 1401 locally stores and manages a large database) then this storage can be provided by peripheral storage devices designed for storing large amounts of data, such as a storage area network (SAN) that is shared by multiple, geographically distributed computers. IoT sensor set 1425 is made up of sensors that can be used in Internet of Things applications. For example, one sensor can be a thermometer and another sensor can be a motion detector.

NETWORK MODULE 1415 is the collection of computer software, hardware, and firmware that allows computer 1401 to communicate with other computers through WAN 1402. Network module 1415 can include hardware, such as modems or Wi-Fi signal transceivers, software for packetizing or de-packetizing data for communication network transmission, or web browser software for communicating data over the internet. In some embodiments, network control functions and network forwarding functions of network module 1415 are performed on the same physical hardware device. In other embodiments (for example, embodiments that utilize software-defined networking (SDN)), the control functions and the forwarding functions of network module 1415 arc performed on physically separate devices, such that the control functions manage several different network hardware devices. Computer readable program instructions for performing the inventive methods can typically be downloaded to computer 1401 from an external computer or external storage device through a network adapter card or network interface included in network module 1415.

WAN 1402 is any wide area network (for example, the internet) capable of communicating computer data over non-local distances by any technology for communicating computer data, now known or to be developed in the future. In some embodiments, the WAN can be replaced or supplemented by local area networks (LANs) designed to communicate data between devices located in a local area, such as a Wi-Fi network. The WAN or LANs typically include computer hardware such as copper transmission cables, optical transmission fibers, wireless transmission, routers, firewalls, switches, gateway computers and edge servers.

END USER DEVICE (EUD) 1403 is any computer system that is used and controlled by an end user (for example, a customer of an enterprise that operates computer 1401) and can take any of the forms discussed above in connection with computer 1401. EUD 1403 typically receives helpful and useful data from the operations of computer 1401. For example, in a hypothetical case where computer 1401 is designed to provide a recommendation to an end user, this recommendation would typically be communicated from network module 1415 of computer 1401 through WAN 1402 to EUD 1403. In this way, EUD 1403 can display, or otherwise present, the recommendation to an end user. In some embodiments, EUD 1403 can be a client device, such as thin client, heavy client, mainframe computer or desktop computer.

REMOTE SERVER 1404 is any computer system that serves at least some data or functionality to computer 1401. Remote server 1404 can be controlled and used by the same entity that operates computer 1401. Remote server 1404 represents the machine(s) that collect and store helpful and useful data for use by other computers, such as computer 1401. For example, in a hypothetical case where computer 1401 is designed and programmed to provide a recommendation based on historical data, then this historical data can be provided to computer 1401 from remote database 1430 of remote server 1404.

PUBLIC CLOUD 1405 is any computer system available for use by multiple entities that provides on-demand availability of computer system resources or other computer capabilities, especially data storage (cloud storage) and computing power, without direct active management by the scale. The direct and active management of the computing resources of public cloud 1405 is performed by the computer hardware or software of cloud orchestration module 1441. The computing resources provided by public cloud 1405 are typically implemented by virtual computing environments that run on various computers making up the computers of host physical machine set 1442, which is the universe of physical computers in or available to public cloud 1405. The virtual computing environments (VCEs) typically take the form of virtual machines from virtual machine set 1443 or containers from container set 1444. It is understood that these VCEs can be stored as images and can be transferred among and between the various physical machine hosts, either as images or after instantiation of the VCE. Cloud orchestration module 1441 manages the transfer and storage of images, deploys new instantiations of VCEs and manages active instantiations of VCE deployments. Gateway 1440 is the collection of computer software, hardware and firmware allowing public cloud 1405 to communicate through WAN 1402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1406 is similar to public cloud 1405, except that the computing resources are only available for use by a single enterprise. While private cloud 1406 is depicted as being in communication with WAN 1402, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 1405 and private cloud 1406 are both part of a larger hybrid cloud.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples of various embodiments. For ease of description or explanation, various portions of the herein disclosure utilize the term “each”, “every”, or “all” when discussing various embodiments. Such usages of the term “each”, “every”, or “all” are non-limiting examples. In other words, when the herein disclosure provides a description that is applied to “each”, “every”, or “all” of some particular object or component, it should be understood that this is a non-limiting example of various embodiments, and it should be further understood that, in various other embodiments, it can be the case that such description applies to fewer than “each”, “every”, or “all” of that particular object or component.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system, comprising:
a processor that executes computer-executable components stored in a non-transitory computer-readable memory, the computer-executable components comprising:
an access component that accesses a large language model and a natural language question for which a ground-truth answer is unavailable; and
a prediction component that generates, via a machine learning classifier that receives as input a set of properties associated with the natural language question, a classification label indicating whether or not the large language model will correctly answer the natural language question.

2. The system of claim 1, wherein the machine learning classifier is a logistic regression model.

3. The system of claim 1, wherein the set of properties comprise a continuous variable indicating an amount of popularity of a grammatical subject or grammatical object of the natural language question, wherein the grammatical subject or the grammatical object is identified via named-entity recognition.

4. The system of claim 3, wherein the grammatical subject or the grammatical object of the natural language question corresponds to a website, and wherein the continuous variable is based on a number of monthly views of the website.

5. The system of claim 1, wherein the prediction component executes the large language model on the natural language question a plurality of times using a non-greedy decoding mode of the large language model, thereby yielding a plurality of synthesized answers, and wherein the set of properties comprise a continuous variable indicating a semantic consistency of the plurality of synthesized answers.

6. The system of claim 5, wherein the semantic consistency is based on a mean pairwise cosine similarity of embeddings of the plurality of synthesized answers.

7. The system of claim 1, wherein the prediction component executes the large language model on the natural language question and on a plurality of paraphrases of the natural language question, thereby yielding a plurality of synthesized answers, and wherein the set of properties comprise a continuous variable indicating a semantic consistency of the plurality of synthesized answers.

8. The system of claim 1, wherein the set of properties comprise a categorical variable indicating a semantic category to which the natural language question belongs.

9. A computer-implemented method, comprising:
accessing, by a device operatively coupled to a processor, a large language model and a natural language question for which a ground-truth answer is unavailable; and
generating, by the device and via a machine learning classifier that receives as input a set of properties associated with the natural language question, a classification label indicating whether or not the large language model will correctly answer the natural language question.

10. The computer-implemented method of claim 9, wherein the machine learning classifier is a logistic regression model.

11. The computer-implemented method of claim 9, wherein the set of properties comprise a continuous variable indicating an amount of popularity of a grammatical subject or grammatical object of the natural language question, wherein the grammatical subject or the grammatical object is identified via named-entity recognition.

12. The computer-implemented method of claim 11, wherein the grammatical subject or the grammatical object of the natural language question corresponds to a website, and wherein the continuous variable is based on a number of monthly views of the website.

13. The computer-implemented method of claim 9, wherein the device executes the large language model on the natural language question a plurality of times using a non-greedy decoding mode of the large language model, thereby yielding a plurality of synthesized answers, and wherein the set of properties comprise a continuous variable indicating a semantic consistency of the plurality of synthesized answers.

14. The computer-implemented method of claim 13, wherein the semantic consistency is based on a mean pairwise cosine similarity of embeddings of the plurality of synthesized answers.

15. The computer-implemented method of claim 9, wherein the device executes the large language model on the natural language question and on a plurality of paraphrases of the natural language question, thereby yielding a plurality of synthesized answers, and wherein the set of properties comprise a continuous variable indicating a semantic consistency of the plurality of synthesized answers.

16. The computer-implemented method of claim 9, wherein the set of properties comprise a categorical variable indicating a semantic category to which the natural language question belongs.

17. A computer program product for facilitating ground-truth-less performance prediction of generative question-answering systems, the computer program product comprising a non-transitory computer-readable memory having program instructions embodied therewith, the program instructions executable by a processor to cause the processor to:
access a large language model and a natural language question for which a ground-truth answer is unavailable; and
generate, via a machine learning classifier that receives as input a set of properties associated with the natural language question, a classification label indicating whether or not the large language model will correctly answer the natural language question.

18. The computer program product of claim 17, wherein the set of properties comprise:
a first continuous variable indicating an amount of semantic consistency of a plurality of first synthesized answers that the large language model non-greedily generates for the natural language question; or
a second continuous variable indicating an amount of semantic consistency of a plurality of second synthesized answers that the large language model generates for the natural language question and for a plurality of paraphrases of the natural language question.

19. The computer program product of claim 18, wherein the set of properties comprise a third continuous variable indicating a website popularity of a grammatical subject or object of the natural language question.

20. The computer program product of claim 18, wherein the set of properties comprise a categorical variable indicating a semantic category to which the natural language question belongs.
